(19) United States
(12) Patent Application Publication
(10) Pub. No.: US 2023/0353226 A1
(43) Pub. Date: Nov. 2, 2023

(54) REPORT INCLUDING A CONFIDENCE FOR A REPORT QUANTITY

(71) Applicant: QUALCOMM Incorporated, San Diego, CA (US)

(72) Inventors: Tianyang Bai, Somerville, NJ (US); Hua Wang, Basking Ridge, NJ (US); Taesang Yoo, San Diego, CA (US); Junyi Li, Fairless Hills, PA (US); Tao Luo, San Diego, CA (US)

(21) Appl. No.: 18/308,568

(22) Filed: Apr. 27, 2023

Related U.S. Application Data
(60) Provisional application No. 63/363,942, filed on Apr. 29, 2022.

(51) Int. Cl. H04B 7/08; H04W 72/542

(52) U.S. Cl. CPC H04B 7/088; H04W 72/542

(57) ABSTRACT

An apparatus of the present disclosure may be a network node, such as a user equipment (UE), or a component thereof. The apparatus may be configured to determine a set of values respectively corresponding to a set of signals received from a second network node, and the set of signals corresponds to a set of beams. The apparatus may be further configured to determine, based on the set of values, at least one predicted value, wherein the at least one predicted value corresponds to at least one beam with which to communicate with the second network node. The apparatus may be further configured to transmit, to the second network node, a report, and the report may include information indicating at least one confidence score that is associated with the at least one predicted value.

This application claims the benefit of U.S. Provisional Application No. 63/363,942, filed Apr. 29, 2022, the entire contents of which are hereby incorporated by reference.

### INTRODUCTION

The present disclosure generally relates to communication systems, and more particularly, to reporting a confidence score related to a report quantity, such as a prediction for a channel quality on a beam.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a network node, such as a user equipment (UE), or a component thereof. The apparatus may be configured to determine a set of values respectively corresponding to a set of signals received from a second network node, and the set of signals corresponds to a set of beams. The apparatus may be further configured to determine, based on the set of values, at least one predicted value, wherein the at least one predicted value corresponds to at least one beam with which to communicate with the second network node. The apparatus may be further configured to transmit, to the second network node, a report, and the report may include information indicating at least one confidence score that is associated with the at least one predicted value.

In another aspect of the disclosure, another method, another computer-readable medium, and another apparatus are provided. The other apparatus may be a network node, such as a base station, or a component thereof. The other apparatus may be configured to receive, from a second network node, a report including information indicating at least one confidence score associated with at least one predicted value corresponding to at least one beam with which to communicate with the second network node. The other apparatus may be further configured to communicate with the second network node using a selected beam that is based on the information indicating the at least one confidence score.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink channels within a subframe, in accordance with various aspects of the present disclosure.

FIG. 3 is a diagram illustrating an example of a base station and user equipment (UE) in an access network.

FIG. 4 is a diagram illustrating an example of a prediction function.

FIG. 5 is a diagram illustrating an example of a prediction function configured to predict measurements for beams.

FIG. 6A is diagram illustrating an example of a UE in communication with a base station having a prediction function.

FIG. 6B is diagram illustrating an example of a base station having a prediction function in communication with a UE.

FIG. 6C is diagram illustrating an example of a base station having a prediction function in communication with a UE having a prediction function.

FIG. 7 is a diagram illustrating an example of a prediction function that is configured to receive at least one measurement as an input and to provide a predicted measurement and a confidence score for the predicted measurement as outputs.

FIG. 8 is a call flow diagram illustrating an example of a UE that is configured to report a confidence score associated with a predicted measurement to a base station based on a configuration provided by the base station.

FIG. 9 is a flowchart illustrating an example of a method of wireless communication at a UE.

FIG. 10 is a flowchart illustrating an example of a method of wireless communication at a base station.

FIG. 11 is a diagram illustrating an example of a hardware implementation for an example apparatus.

FIG. 12 is a diagram illustrating another example of a hardware implementation for another example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, the concepts and related aspects described in the present disclosure may be implemented in the absence of some or all of such specific details. In some instances, well-known structures, components, and the like are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure.

One or more processors in the processing system may execute software. Software shall be construed broadly to mean instructions, instruction sets, computer-executable code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or computer-executable code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer-executable code in the form of instructions or data structures that can be accessed by a computer.

As described herein, a node (which may be referred to as a node, a network node, a network entity, or a wireless node) may include, be, or be included in (e.g., be a component of) a base station (e.g., any base station described herein), a user equipment (UE) (e.g., any UE described herein), a network controller, an apparatus, a device, a computing system, an integrated access and backhauling (IAB) node, a distributed unit (DU), a central unit (CU), a remote unit (RU), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more components, a first processing entity, or the like configured to receive the information; and the second network node may refer to a second UE, a second base station, a second apparatus, a second device, a second computing system, a second set of one or more components, a second processing entity, or the like.

In various wireless communication environments, such as a radio access network (RAN), some network nodes may communicate using beamforming, e.g., in a millimeter wave (mmW) spectrum. Beams on which a UE and a base station communicate may be susceptible to blockers and other channel interference. Thus, measurements indicative of a channel quality on a beam, such as reference signal receive power (RSRP), signal-to-noise ratio (SNR), signal-to-interference-plus-noise ratio (SINR), reference signal receive quality (RSRQ), channel quality indicator (CQI), and/or reference signal strength indicator (RSSI) measurements or values, may change by nonnegligible amounts over short durations due to random variance, including fading of channels and/or uncertainty regarding the exact location of the UE at a future time given historical measurements. Therefore, such historical actual measurements may be obsolete when made available to the base station to configure communication with the UE.

One approach to avoiding the use of stale or obsolete measurements to configure communication is to predict a future measurement, e.g., for a future time step at which the predicted measurement may be accurate. As measurements may change relatively frequently, and the distributions of measurements may differ in different locations, a predicted measurement may be predicted as a value (e.g., mean future RSRP, mean future SNR) that is the mean of several other values, such as one or more actual measurements. The actual measurements may be provided to a function as inputs, and accordingly, one or more predicted measurements, such a mean predicted RSRP and/or mean predicted SNR may be output.

While predicted measurements may improve link quality in some instances and reduce occurrences of radio link failure, such communication attributes may be supplemented by information indicating a reliability of the (mean) predicted measurement. Such information indicating the reliability of a (mean) predicted measurement may include a confidence score, which may include at least one of a standard deviation, a variance, a probability, a likelihood, or the like. Some functions may be configured to generate confidence scores in association with predicted measurements to indicate the reliability of associated predicted measurements at a future time(s). For example, some functions may generate predicted measurements and associated confidence scores based on a set of actual measurements over a preceding time period.

In some aspects, a variance that satisfies a threshold (e.g., greater than or equal to a variance threshold) may indicate a relatively low degree of reliability in an associated predicted measurement. In contrast, a variance that fails to satisfy the threshold (e.g., the variance is less than the threshold) may indicate a relatively great degree of reliability in the associated predicted measurement, and such a great degree of reliability may be suitable for use in configuring communication by a base station.

Accordingly, rather than simply reporting a mean predicted measurement, a UE may be configured to report a confidence score associated with the predicted measurement to the base station, e.g., in order for the base station to make accurate scheduling decisions.

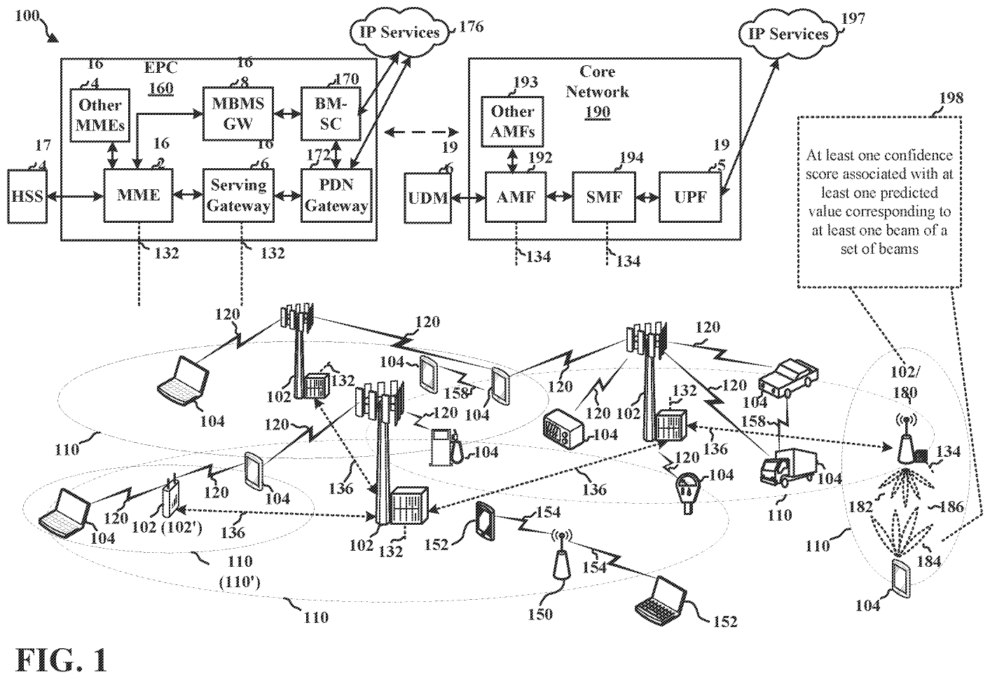

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR), which may be collectively referred to as Next Generation RAN (NG-RAN), may interface with core network 190 through second backhaul links 134. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, Multimedia Broadcast Multicast Service (MBMS), subscriber and equipment trace, RAN information management (RIM), paging, positioning, and delivery of warning messages.

In some aspects, the base stations 102 may communicate directly or indirectly (e.g., through the EPC 160 or core network 190) with each other over third backhaul links 136 (e.g., X2 interface). The first backhaul links 132, the second backhaul links 134, and the third backhaul links 136 may be wired, wireless, or some combination thereof. At least some of the base stations 102 may be configured for IAB. Accordingly, such base stations may wirelessly communicate with other base stations, which also may be configured for IAB.

At least some of the base stations 102 configured for IAB may have a split architecture that includes at least one of a CU, a DU, an RU, a radio unit, and/or a remote radio head (RRH), some or all of which may be collocated or distributed and/or may communicate with one another. In some configurations of such a split architecture, a CU may implement some or all functionality of a radio resource control (RRC) layer, whereas a DU may implement some or all of the functionality of a radio link control (RLC) layer.

Illustratively, some of the base stations 102 configured for IAB may communicate through a respective CU with a DU of an IAB donor node or other parent IAB node (e.g., a base station), and further, may communicate through a respective DU with child IAB nodes (e.g., other base stations) and/or one or more of the UEs 104. One or more of the base stations 102 configured for IAB may be an IAB donor connected through a CU with at least one of the EPC 160 and/or the core network 190. With such a connection to the EPC 160 and/or core network 190, a base station 102 operating as an IAB donor may provide a link to the EPC 160 and/or core network 190 for one or more UEs and/or other IAB nodes, which may be directly or indirectly connected (e.g., separated from an IAB donor by more than one hop) with the IAB donor. In the context of communicating with the EPC 160 or the core network 190, both the UEs and IAB nodes may communicate with a DU of an IAB donor. In some additional aspects, one or more of the base stations 102 may be configured with connectivity in an open RAN (ORAN) and/or a virtualized RAN (VRAN), which may be enabled through at least one respective CU, DU, RU, RRH, and/or remote unit.

The base stations 102 may wirelessly communicate with the UEs 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Each of the base stations 102 may provide communication coverage for a respective geographic coverage area 110, which may also be referred to as a “cell.” Potentially, two or more geographic coverage areas 110 may at least partially overlap with one another, or one of the geographic coverage areas 110 may contain another of the geographic coverage areas. For example, the small cell 102′ may have a coverage area 110′ that overlaps with the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use multiple-input and multiple-output (MIMO) antenna technology, including spatial multiplexing, beamforming, and/or transmit diversity. Wireless links or radio links may be on one or more carriers, or component carriers (CCs). The base stations 102 and/or UEs 104 may use spectrum up to Y megahertz (MHz) (e.g., Y may be equal to or approximately equal to 5, 10, 15, 20, 100, 400, etc.) bandwidth per carrier allocated in a carrier aggregation of up to a total of Yx MHz (e.g., x CCs) used for transmission in each direction. The CCs may or may not be adjacent to each other. Allocation of CCs may be asymmetric with respect to downlink and uplink (e.g., more or fewer CCs may be allocated for downlink than for uplink).

The CCs may include a primary CC and one or more secondary CCs. A primary CC may be referred to as a primary cell (PCell) and each secondary CC may be referred to as a secondary cell (SCell). The PCell may also be referred to as a “serving cell” when the UE is known both to a base station at the access network level and to at least one core network entity (e.g., AMF and/or MME) at the core network level, and the UE may be configured to receive downlink control information in the access network (e.g., the UE may be in an RRC Connected state). In some instances in which carrier aggregation is configured for the UE, each of the PCell and the one or more SCells may be a serving cell.

Certain UEs 104 may communicate with each other using device-to-device (D2D) communication link 158. The D2D communication link 158 may use the downlink/uplink WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (or “mmWave” or simply “mmW”) band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, the term “sub-6 GHz,” “sub-7 GHz,” and the like, to the extent used herein, may broadly represent frequencies that may be less than 6 GHz, frequencies that may be less than 7 GHz, frequencies that may be within FR1, and/or frequencies that may include mid-band frequencies. Further, unless specifically stated otherwise, the term “millimeter wave” and other similar references, to the extent used herein, may broadly represent frequencies that may include mid-band frequencies, frequencies that may be within FR2, and/or frequencies that may be within the EHF band.

A base station 102, whether a small cell 102′ or a large cell (e.g., macro base station), may include and/or be referred to as an eNB, gNodeB (gNB), or another type of base station. Some base stations 180, such as gNBs, may operate in a traditional sub 6 GHz spectrum, in mmW frequencies, and/or near-mmW frequencies in communication with the UE 104. When such a base station 180 (e.g., gNB) operates in mmW or near-mmW frequencies, the base station 180 may be referred to as a mmW base station. The (mmW) base station 180 may utilize beamforming 186 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182. The UE 104 may receive the beamformed signal from the base station 180 in one or more receive directions 184. The UE 104 may also transmit a beamformed signal to the base station 180 in one or more transmit directions. The base station 180 may receive the beamformed signal from the UE 104 in one or more receive directions. One or both of the base station 180 and/or the UE 104 may perform beam training to determine the best receive and/or transmit directions for the one or both of the base station 180 and/or UE 104. The transmit and receive directions for the base station 180 may or may not be the same. The transmit and receive directions for the UE 104 may or may not be the same.

In various different aspects, one or more of the base stations 102/180 may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology.

In some aspects, one or more of the base stations 102/180 may be connected to the EPC 160 and may provide respective access points to the EPC 160 for one or more of the UEs 104. The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, with the Serving Gateway 166 being connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a Packet Switch (PS) Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

In some other aspects, one or more of the base stations 102/180 may be connected to the core network 190 and may provide respective access points to the core network 190 for one or more of the UEs 104. The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a PS Streaming Service, and/or other IP services.

In certain aspects, the UE 104 may be configured to determine a set of values respectively corresponding to a set of signals received from the base station 102/180. The set of signals may correspond to a set of beams in the transmit directions 182 of the base station 102/180. The UE 104 may be further configured to determine, based on the set of values, at least one predicted value, and the at least one predicted value may correspond to at least one beam with which to communicate with the base station 102/180. The UE may be further configured to transmit, to the base station 102/180, a report, and the report may include information indicating at least one confidence score 198 that is associated with the at least one predicted value.

Correspondingly, the base station 102/180 may be configured to receive, from the UE 104, a report including information indicating the at least one confidence score 198 associated with the at least one predicted value corresponding to the at least one beam with which to communicate with the UE 104. The base station 102/180 may be further configured to communicate with the UE 104 using a selected beam that is based on the information indicating the at least one confidence score.

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

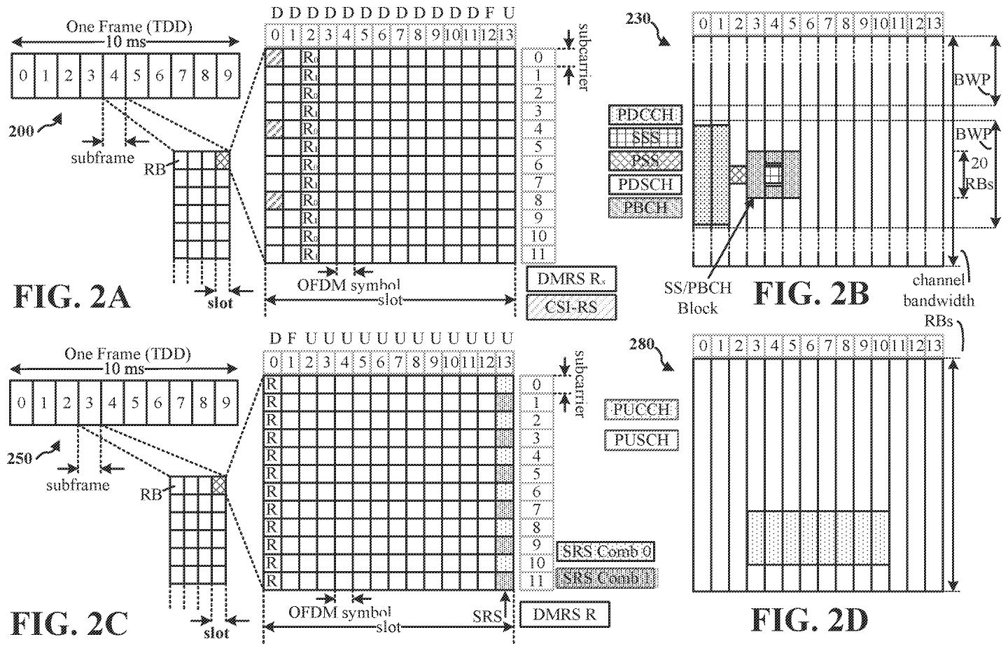

FIG. 2A is a diagram illustrating an example of a first subframe 200 within a 5G NR frame structure. FIG. 2B is a diagram illustrating an example of downlink channels within a 5G NR subframe 230. FIG. 2C is a diagram illustrating an example of a second subframe 250 within a 5G NR frame structure. FIG. 2D is a diagram illustrating an example of uplink channels within a 5G NR subframe 280. The 5G NR frame structure may be frequency division duplexed (FDD) in which for a particular set of subcarriers (carrier system bandwidth), subframes within the set of subcarriers are dedicated for either downlink or uplink, or may be time division duplexed (TDD) in which for a particular set of subcarriers (carrier system bandwidth), subframes within the set of subcarriers are dedicated for both downlink and uplink. In the examples provided by FIGS. 2A, 2C, the 5G NR frame structure is assumed to be TDD, with subframe 4 being configured with slot format 28 (with mostly downlink), where D is downlink, U is uplink, and F is flexible for use between downlink/uplink, and subframe 3 being configured with slot format 34 (with mostly uplink). While subframes 3, 4 are shown with slot formats 34, 28, respectively, any particular subframe may be configured with any of the various available slot formats 0-61. Slot formats 0, 1 are all downlink, uplink, respectively. Other slot formats 2-61 include a mix of downlink, uplink, and flexible symbols. UEs are configured with the slot format (dynamically through downlink control information (DCI), or semi-statically/statically through RRC signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on downlink may be cyclic prefix (CP) orthogonal frequency-division multiplexing (OFDM) (CP-OFDM) symbols. The symbols on uplink may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 microseconds (μs). Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry at least one pilot signal, such as a reference signal (RS), for the UE. Broadly, RSs may be used for beam training and management, tracking and positioning, channel estimation, and/or other such purposes. In some configurations, an RS may include at least one demodulation RS (DM-RS) (indicated as Rₓ for one particular configuration, where 100x is the port number, but other DM-RS configurations are possible) and/or at least one channel state information (CSI) RS (CSI-RS) for channel estimation at the UE. In some other configurations, an RS may additionally or alternatively include at least one beam measurement (or management) RS (BRS), at least one beam refinement RS (BRRS), and/or at least one phase tracking RS (PT-RS).

FIG. 2B illustrates an example of various downlink channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the uplink.

FIG. 2D illustrates an example of various uplink channels within a subframe of a frame. The PUCCH may be located as indicated in one configuration. The PUCCH carries uplink control information (UCI), which may include a scheduling request (SR), a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

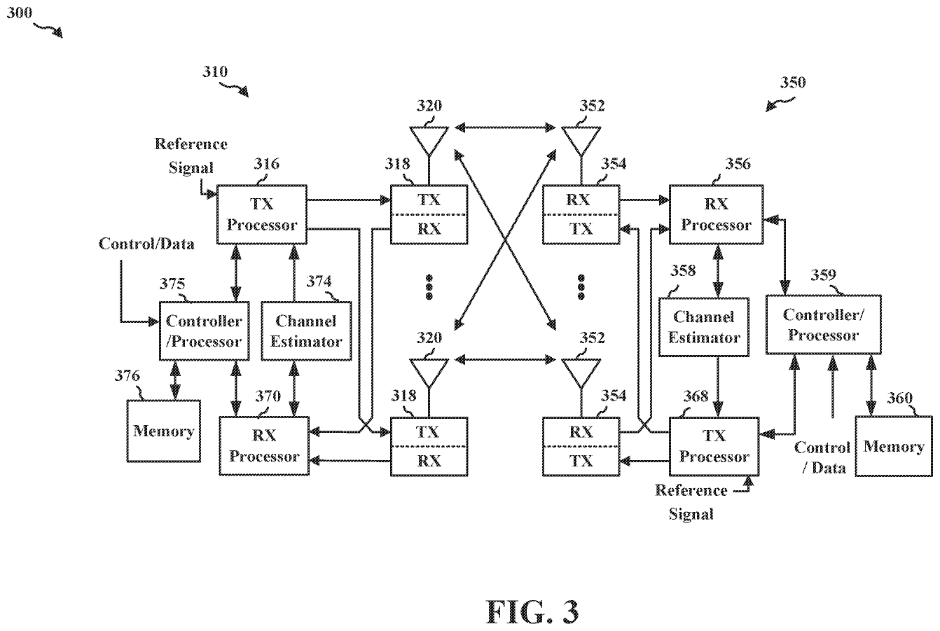

FIG. 3 is a block diagram of a base station 310 in communication with a UE 350 in an access network 300. In the downlink, IP packets from the EPC 160 may be provided to a controller/processor 375. The controller/processor 375 implements Layer 2 (L2) and Layer 3 (L3) functionality. L3 includes an RRC layer, and L2 includes a service data adaptation protocol (SDAP) layer, a packet data convergence protocol (PDCP) layer, an RLC layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement Layer 1 (L1) functionality associated with various signal processing functions. L1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate a radio frequency (RF) carrier with a respective spatial stream for transmission.

At the UE 350, each receiver 354RX receives a signal through at least one respective antenna 352. Each receiver 354RX recovers information modulated onto an RF carrier and provides the information to the receive (RX) processor 356. The TX processor 368 and the RX processor 356 implement L1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements L3 and L2 functionality.

The controller/processor 359 can be associated with a memory 360 that stores program codes and data. The memory 360 may be referred to as a computer-readable medium. In the uplink, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the downlink transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The uplink transmission is processed at the base station 310 in a manner similar to that described in connection with the receiver function at the UE 350. Each receiver 318RX receives a signal through at least one respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the uplink, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

In some aspects, at least one of the TX processor 368, the RX processor 356, and the controller/processor 359 may be configured to perform aspects in connection with reported confidence score 198 of FIG. 1.

In some other aspects, at least one of the TX processor 316, the RX processor 370, and the controller/processor 375 may be configured to perform aspects in connection with the reported confidence score 198 of FIG. 1.

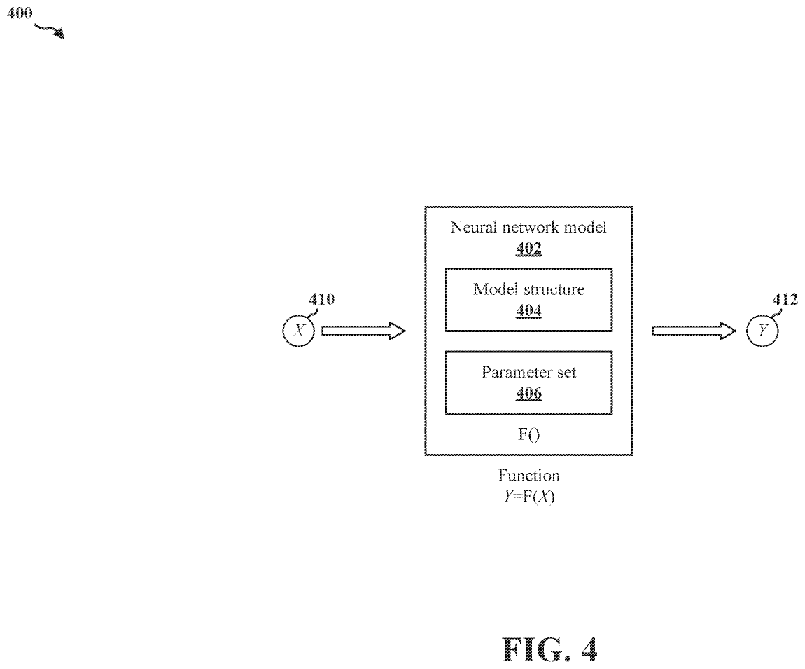

FIG. 4 is a diagram illustrating an example of a prediction function 400. The prediction function 400 may be a function, e.g., represented as Y=F(X), and may be identifiable via an identifier (ID), such as a neural network function (NNF) ID, which may be standardized or non-standardized (e.g., non-standardized for private extensions). The prediction function 400 may be configured to accept an input X 410 and return an output Y 412 and, in some aspects, the input X 410 and the output Y 412 may be standardized.

In some aspects, the prediction function 400 may be implemented at a UE, and in some further aspects, a prediction function implemented at a UE may be configurable by a base station. For example, a base station may transmit one or more RRC signaling messages to the UE to configure the prediction function of the UE. Such RRC signaling messages may include some information elements (IEs) that may be compulsory, e.g., to obtain accurate outputs of the prediction function 400, and/or some IEs that may be optional, e.g., to facilitate flexibility across implementations of prediction functions.

The prediction function 400 may be supported by a model, such as a neural network model 402. Examples of the neural network model 402 may include, inter alia, long short-term memory (LSTM), a convolutional neural network (CNN), a recurrent neural network (RNN), an attention model, a deep-learning model, and so forth. However, other models may be used without departing from the scope of the present disclosure. For example, the neural network model 402 may be replaced by or supplemented with a filter-based model, such as an MMSE filtering model, an optimization model, such as a Bayesian optimization model, or other such statistical model.

The neural network model 402 may include a model structure 404 and a parameter set 406. The neural network model 402 may be implementation-specific, and may be defined by a mobile network operator (MNO), a vendor (e.g., a UE vendor or a base station vendor), and/or another entity In some aspects, one prediction function can be supported by multiple models (e.g., vendor-specific implementation).

In the neural network model 402, the model structure 404 may be identifiable via a model ID, which may include a default parameter set. Such a model ID may be unique in the network, and each model ID may be associated with a prediction function. The parameter set 406 may include weights of the neural network model 402, as well as other configuration parameters. The parameter set 406 may be specific to a location and/or configuration.

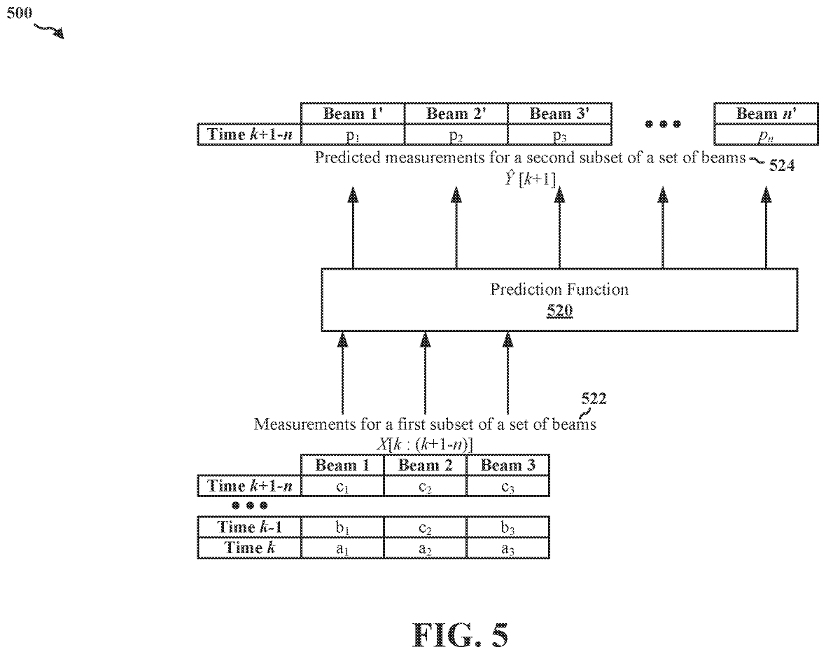

FIG. 5 is a diagram illustrating an example of a prediction function 520 configured to predict measurements 524 for beams. The prediction function 520 may include a set of algorithms that may be designed to predict measurements at a future time, such as a future RSRP or future SNR, based on historical measurements obtained based on receiving signals from the base station 502.

In some aspects, the set of algorithms may include at least one of a neural network, such as a RNN or other neural network composed of a set of interconnected activation functions, a set of algorithms for filtering and/or optimization, and/or another set of algorithms. In some aspects, the set of algorithms may be trained and maintained by a base station. In some other aspects, the set of algorithms can be executed by the base station and/or the UE. When executed at the UE, the set of algorithms may be configured by the base station.

A UE may be configured to obtain actual measurements 522 for a first subset of a set of beams (e.g., beams having IDs 1, 2, and 3) at a plurality of time steps k, k−1, k+1−n. These actual measurements 522 may be represented in a vector having a number of elements equal to the number of beams being tracked by the UE (e.g., three (3) beams, eight (8) beams, twenty-four (24) beams, etc.), with each time step k, k−1, k+1−n being represented in a respective vector. Such vectors may be provided to the prediction function 520 as inputs. The prediction function 520 may return a set of outputs that may include predicted measurements 524 for a second subset of the set of beams.

For example, the UE may measure a subset of a set of signals (e.g., SSBs, CSI-RSs, etc.) transmitted by the base station in order to predict measurements for one, some, or all signals (e.g., SSBs, CSI-RSs, etc.) at a future time step. For example, the UE may measure SSBs to predict measurements for refining CSI-RS beams for unicast PDSCH/PDCCH. In some other example, the prediction function 520 may be configured to provide an ID of a beam predicted to be the “best” at a future time step (e.g., a beam predicted to have a highest RSRP, highest SNR, other similar metric).

Thus, the prediction function 520 may serve to reduce the overhead commensurate with reference signal transmission. As some measurements may be predicted rather than actual, the frequency with which reference signals are transmitted to track beam or channel qualities may be reduced. Further, a UE may refrain from feeding back channel estimations to the base station so frequently. Further, a UE may conserve more power by refraining from measuring and feeding back measurements to a base station so frequently.

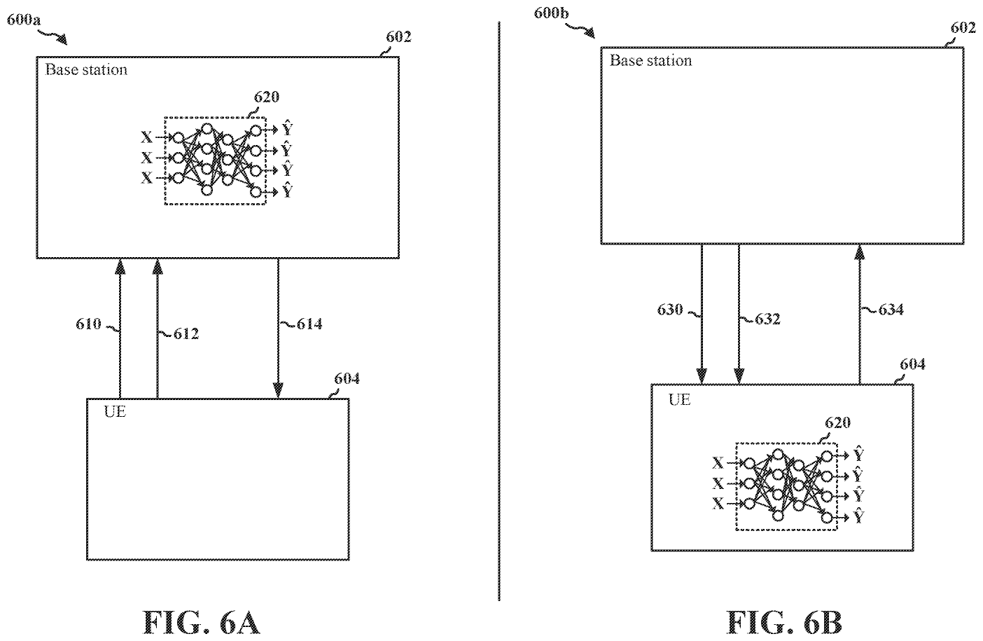

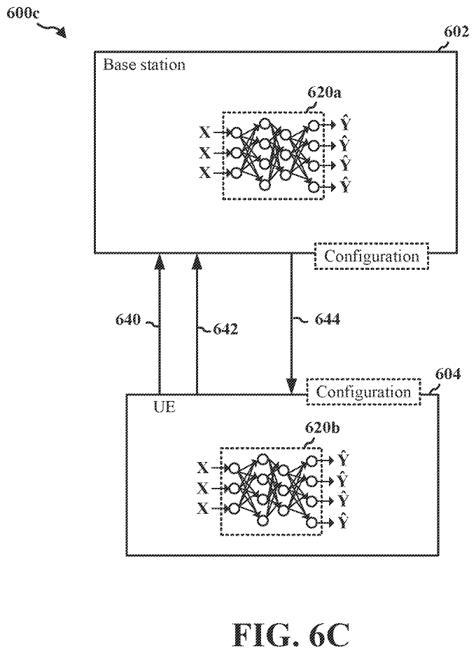

FIG. 6A is diagram illustrating an example configuration 600a of a UE 604 in communication with a base station 602 having a prediction function 620. In the illustrated configuration 600a, the prediction function 620 may be executed at the base station 602. In such an aspect, the UE 604 may transmit, to the base station 602, a CSI or beam report 610. In some other aspects, the UE may additionally or alternatively transmit a set of SRSs 612 that the base station 602 may be configured to detect and measure.

The base station 602 may execute the prediction function 620 based on at least one of UE feedback (e.g., CSI or beam report 610) and/or SRSs 620 transmitted by the UE 604. Based on an output(s) of the prediction function, base station 602 may be configured to transmit, to the UE 604, information 614 indicating at least one of a predicted measurement(s) and/or a schedule or resource allocation for the UE 604 on a beam that is predicted to have an acceptable and reliable measurement at a future time step. Such a configuration 600a may be particularly useful when power and/or processing capacity are limited at the UE 604.

FIG. 6B is diagram illustrating an example configuration 600b of a base station 602 having a prediction function 620 in communication with a UE 604. In the illustrated configuration, the prediction function 620 may be executed at the UE 604. However, the prediction function 620 may be configured by the base station 602 for the UE 604. To that end, the base station 602 may transmit a prediction function configuration 630 to the UE 604 that may include a set of weights and/or parameters with which to configure the prediction function 620.

Further, the base station 602 may transmit a set of reference signals 632 to the UE 604. The UE 604 may determine measurement information based on receiving the set of reference signals 632. For example, the UE 604 may measure an RSRP or an SNR based on receiving at least one of the reference signals 632. The UE 604 may execute the prediction function 620, configured with the prediction function configuration 630, using the determined measurement information (e.g., actual measurements based on the reference signals 632). The UE 604 may obtain one or more outputs of the prediction function 620, which may include predicted measurements based on the input measurement information. The UE 604 may transmit, to the base station 602, a report 634 that indicates the predicted measurements obtained based on output(s) of the prediction function 620.

The configuration 600b in which the prediction function 620 is implemented at the UE 604 may be advantageous in terms of accuracy, as the UE 604 may have more actual measurements than those reported to the base station 602, and further, the signaling overhead commensurate with transmitting or receiving predicted measurements may be reduced relative to the first configuration 600a.

FIG. 6C is diagram illustrating an example configuration 600c of a base station 602 having a prediction function 640 in communication with a UE 604 having a prediction function 640. In the illustrated configuration 600c, one prediction function 620a may be executed at the base station 602, and another prediction function 620b may be executed at the UE 604.

The prediction function 620b at the UE 604 may be configured by the base station 602. In such an aspect, the base station 602 may transmit a prediction function configuration 640 to the UE 604, and the prediction function configuration 640 may configure the UE-side prediction function 620b to be consistent with the base station-side prediction function 620a.

For example, the prediction function configuration 640 may include a set of weights or parameters that is based on a corresponding set of weights or parameters with which the base station-side prediction function 620a is configured. In some aspects, the prediction function configuration 640 may configure the UE-side prediction function 620b to generate one or more output(s) that are the same or substantially similar to one or more corresponding output(s) of the base station-side prediction function 620a, e.g., when the prediction functions 620a, 620b are provided the same set of inputs.

In some aspects, the outputs of the prediction functions 620a, 620b may be based on actual measurements taken from reference signals 642 transmitted by the base station 602. The UE 604 may determine measurement information based on receiving the set of reference signals 642. For example, the UE 604 may measure an RSRP or an SNR based on receiving at least one of the reference signals 642. The UE 604 may report at least a portion of the measurement information (e.g., including at least a portion of the actual measurements that are based on the reference signals 642) to the base station 602 in a CSI or beam report 610.

With inputs based on the measurement information, each of the base station 602 and the UE 604 may independently execute a respective prediction function 620a, 620b. As the prediction function configuration 630 configures the UE-side prediction function 620b to be consistent with the base station-side prediction function 620a, each of the prediction functions 620a, 620b may independently generate a respective set of outputs (e.g., set of predicted measurements) that is the same or substantially similar given the same set of inputs that is based on the measurement information.

When the base station 602 and the UE 604 are provided the same set out outputs from the respective prediction functions 620a, 620b, the base station 602 and the UE 604 may autonomously configure communication with one another without any signaling overhead (or with appreciably reduced signaling overhead). The base station 602 and the UE 604 may be synchronized for the autonomous configuration 646a, 646b, and because the respective sets of outputs may indicate the same predicted measurements, the autonomous configuration 646b by the UE 604 may result in identification of a beam that the base station 602 will select to communicate with the UE 604 based on the base station-side autonomous configuration 646.

Illustratively, both the base station 602 and the UE 604 may independently predict a beam failure of the current serving beam at a future time step based on respective sets of outputs of the prediction functions 620a, 620b. The respective sets of outputs of the predictions functions 620a, 620b may further indicate a predicted measurement for another beam that offers satisfactory link quality at the future time step. The predicted beam failure may trigger respective autonomous configurations 646a, 646b at the base station 602 and at the UE 604, and both the base station 602 and the UE 604 may perform a beam update procedure to switch from the beam that is predicted to fail to the other beam that is predicted to offer satisfactory link quality in advance of the future time step at which the current beam is predicted to fail. Accordingly, latency and signaling overhead commensurate with generating and transmitting a beam update instruction by the base station 602 may be reduced.

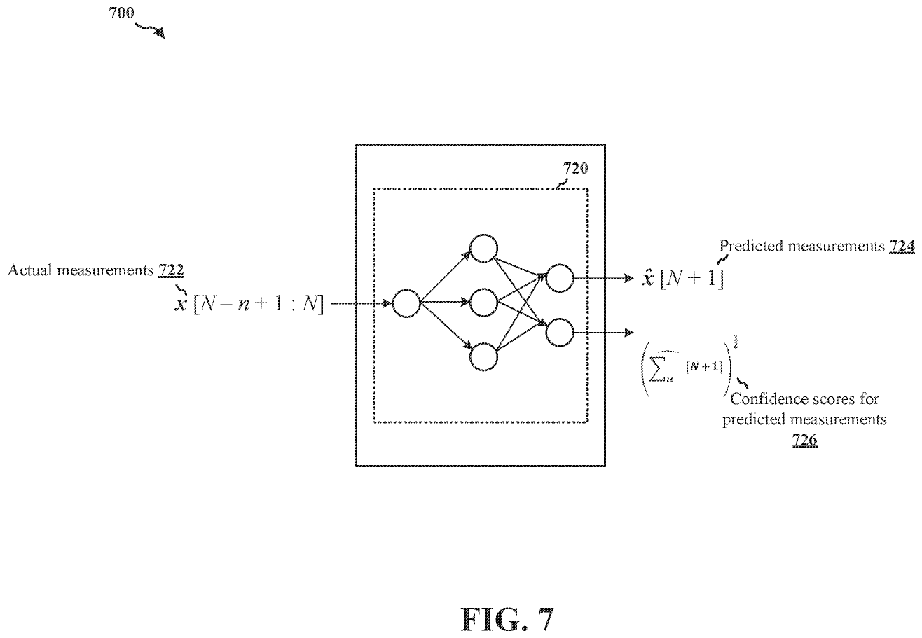

FIG. 7 is a diagram illustrating an example of a prediction function 700 that includes a model 720 configured to receive a set of actual measurements 722 as an input and to provide predicted measurements 724 and confidence scores 726 for the predicted measurements 724 as outputs. The illustrated model 720 may be or may include an neural network, such as an RNN (e.g., an LSTM), CNN, etc., a filtering model, such as an MMSE filtering model, an optimization model, such as a Bayesian optimization model, and so forth. The model 720 may be trained with a negative log likelihood (NLL) loss function, e.g., such that the model is trained to simplify a covariance matrix Σ in NLL loss as a diagonal matrix.

The model 720 may include may be configured with two output heads, a first of which may be configured to output predicted measurements, such as mean RSRP predictions or mean SNR predictions, and a second of which may be configured to output confidence scores corresponding to the predicted measurements, such as standard deviations, variances, probabilities, and/or likelihoods.

A UE or other network node configured with the prediction function 700 may be configured to track a set of reference signals respectively corresponding to a set of Z beams over a set of n time steps beginning at time N−n+1 and ending at time N. For example, the UE may track Z=24 reference signals (e.g., SSBs or CSI-RSs) over n=8 time steps. An input x may include a set of actual measurements 722 (e.g., RSRP measurements and/or SNR measurements) that may be represented in a Z×1 vector at each of the n time steps.

Based on the input x of actual measurements 722, the model 720 may be trained to output predicted measurements 724, which may be include mean predicted measurements (e.g., mean predicted RSRPs, mean predicted SNRs, etc.) represented as a Z×1 vector. In the Z×1 vector of the predicted measurements 724, each element may represent a mean predicted measurement corresponding to a respective one of the Z beams at a future time step N+1, with each of the Z elements of the vector being predicted from each corresponding element of the Z×1 vectors of the actual measurements 722 over the n past time steps.

Further, the model 720 may be trained to output confidence scores 726 represented as a Z×1 vector having elements that respectively correspond to the Z elements of the predicted measurements 724. In some aspects, the confidence scores 726 may include standard deviations of actual measurements distributed over the n time steps. For example, the confidence scores 726 may include the square root of the diagonal elements in a covariance matrix. The confidence scores 726 may be used as indicators of reliabilities of the predicted measurements 724.

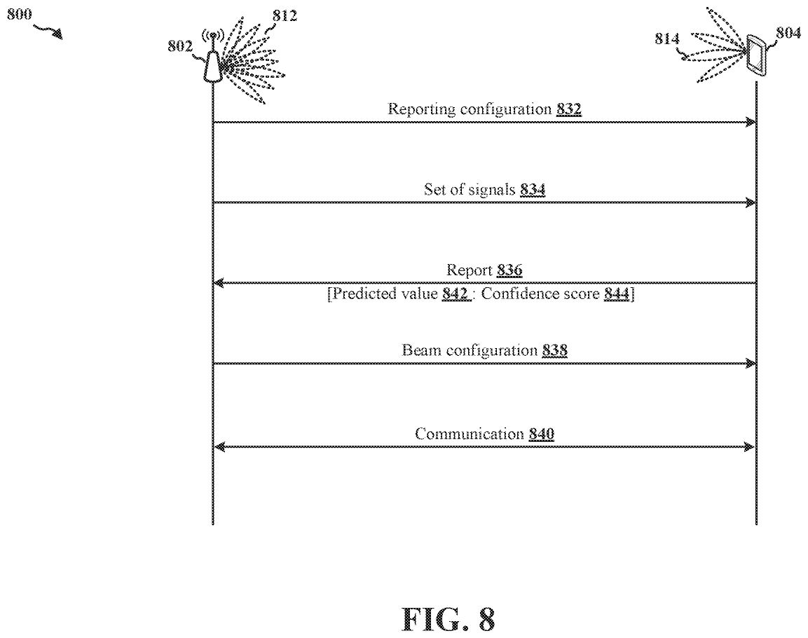

FIG. 8 is a call flow diagram illustrating an example communication flow 800 between a UE 804 that is configured to report a confidence score 844 associated with a predicted measurement 842 to a base station 802 based on a configuration 832 provided by the base station. In the illustrated communication flow 800, the UE 804 may be configured with a prediction function, whereas the base station 802 may not use a prediction function (see, e.g., FIG. 6B). Thus, the UE 604 may be configured to report one or more predicted measurements and associated confidence score(s) to the base station 802 so that the base station 802 is able to schedule the UE 804 on a beam at a future time step.

The base station 802 may transmit, and the UE 804 may receive, a reporting configuration 832 indicative of information to be included in a report 836. For example, the reporting configuration 832 may indicate that the report 836 should include at least one value of a set of values is measured from at least one signal of a set of signals 834, a first indication that the at least one value of the set of values is measured, at least one predicted value 842 that is based on at least one value of the set of values, and/or a second indication that the at least one predicted value 842 corresponds to a prediction. In another example, the reporting configuration 832 indicative of information to be included in the report 836 may indicate that at least one confidence score 844 is to be included in the report 836.

The reporting configuration 832 may further include information indicating at least one quantity of bits associated with the report 836. For example, the information indicating the at least one quantity of bits may indicate that a first quantity of bits is to be used to represent each confidence score 844 of the at least one confidence score 844 in the report 836. In another example, the information indicating the at least one quantity of bits may indicate a first quantity of bits and a second quantity of bits, and the first quantity of bits may be less than the second quantity of bits. Illustratively, the at least one confidence score 844 may include a first confidence score and one or more other confidence scores, and each respective confidence score of the one or more other confidence scores is to be represented by the first quantity of bits, whereas the first confidence score is to be represented by the second quantity of bits.

In still another example, the information indicating the at least one quantity of bits may indicate that each respective confidence score of the at least one confidence score 844 is to be represented by the first quantity of bits in the report 836, and where the report 836 is to include information indicating a first predicted value of the at least one predicted value 842 and a second predicted value of the at least one predicted value 842, the information indicating the at least one quantity of bits may indicate that the first predicted value is to be represented by the first quantity of bits in the report 836 and the second predicted value is to be represented by the second quantity of bits in the report 836.

The base station 802 may transmit, and the UE 804 may receive, a set of signals 834 respectively corresponding to a set of beams 812 of the base station 802. For example, each of the signals 834 may be an SSB or a CSI-RS transmitted on a respective beam of the set of beams 812.

The UE 804 may determine a set of values respectively corresponding to the set of signals 834 received from the base station 802. In various aspects, each of the set of values may be an RSRP value, an RSRQ value, an SNR value, an SINR value, a CQI value, or an RSSI value. The UE 804 may be configured to identify a respective resource on which each of the set of signals 834 is carried, and the UE 804 may be configured to measure the energy or power on the identified respective resource, e.g., to obtain an RSRP value, and/or measure the energy or power on the identified respective resource that corresponds to one of the set of signals 834 and subtract the measurement from the total energy or power on the identified respective resource, e.g., to obtain an SNR value.

In some aspects, to determine the set of values, the UE 804 may be configured to generate measurement information corresponding to the set of signals 834. For example, the UE 804 may generate a vector for each a plurality of time steps, and the UE 804 may populate elements of each vector with measurements obtained based on the set of signals 834 at a respective time step. In some aspects, the measurement information includes the determined set of values, whereas in some other aspects, the UE 804 may process the measurement information resulting in the set of values.

The UE 804 may determine, based on the set of values respectively corresponding to the set of signals 834 received from the base station 802, at least one predicted value 842, and the at least one predicted value 842 may correspond to at least one beam with which to communicate with the base station 802. The at least one predicted value 842 may be at least one predicted RSRP, at least one predicted RSRQ, at least one predicted SNR, at least one predicted SINR, at least one predicted CQI, or at least one predicted RSSI. In some aspects, the at least one predicted value 842 may be a mean predicted value 842. In some aspects, the UE 804 may predict a respective value at future time step for each measured value corresponding to one of the set of beams 812 over each of a set of past time steps. The UE 804 may plot a distribution of the respective values predicted for a future time step—e.g., the UE 804 may plot a point for a predicted value at the future time step predicted from a measured value at past time step N−n+1, the UE 804 may plot another point for another predicted value at the future time step predicted from another measured value at past time step N−n+2, and so forth. The UE 804 may find the mean of the distribution of the plotted points, which may be the mean predicted value 842 corresponding to the one of the set of beams 812 at the future time step. In some aspects, the UE 804 may determine the at least one predicted value 842 further based on at least one of a battery status of the UE 804, a processor utilization of the UE 804, or a capability of the UE 804.

In some aspects, to determine the at least one predicted value 842, the UE 804 may input the set of values into a function. For example, the function may include at least one of a neural network, a deep-learning model, or a filter-based algorithm.

To determine the at least one predicted value 842, the UE 804 may further obtain the at least one predicted value 842 as output of the function based on inputting the set of values.

The UE 804 may determine at least one confidence score 844 associated with the at least one predicted value 842. According to various aspects, the at least one confidence score 844 may include at least one of a variance, a standard deviation, a probability, or a likelihood. The at least one confidence score 844 may be indicative of reliability of the at least one predicted value 842. For example, the UE 804 may predict a respective value at a future time step for each measured value corresponding to one of the set of beams 812 over each of a set of past time steps. The UE 804 may plot a distribution of the respective values predicted for the future time step—e.g., the UE 804 may plot a point for a predicted value at the future time step predicted from a measured value at past time step N−n+1, the UE 804 may plot another point for another predicted value at the future time step predicted from another measured value at past time step N−n+2, and so forth. The UE 804 may find the standard deviation and/or the variance of the distribution of the plotted points, which may represent the confidence score 844 of a corresponding mean predicted value 842 at the future time step. In some aspects, the at least one confidence score 844 may be based on at least one of a most recently predicted value corresponding to the at least one beam or a filtered over instantaneous predicted value corresponding to the at least one beam, and the at least one predicted value 842 may include the most recently predicted value or the filtered over instantaneous predicted value.

The UE 804 may transmit, and the base station 802 may receive, a report 836 that includes information indicating the at least one confidence score 844 that is associated with the at least one predicted value 842. According to various aspects, the report 836 may further include at least one of at least one of the set of values respectively corresponding to the set of signals 834 transmitted by the base station, a first indication that the at least one of the set of values is measured, the at least one predicted value 842, or a second indication that the at least one predicted value 842 corresponds to a prediction. In some aspects, the information indicating the at least one confidence score 844 includes at least one quantized value that is based on the at least one confidence score 844. In some other aspects, the report 836 includes a set of IDs respectively associated with each beam of the at least one beam that corresponds to a respective predicted value of the at least one predicted value 842 that satisfies a threshold, and the set of IDs may be based on a respective confidence score of the at least one confidence score 844. In still other aspects, the report 836 includes time information indicative of a respective time to which each respective confidence score of the at least one confidence score 844 corresponds.

The UE 804 may base the report on the reporting configuration 832. For example, the information indicating the at least one quantity of bits may indicate that a first quantity of bits is to be used to represent each confidence score of the at least one confidence score 844. In another example, the information indicating the at least one quantity of bits may indicate a first quantity of bits and a second quantity of bits, and the first quantity of bits may be less than the second quantity of bits. Illustratively, the at least one confidence score 844 may include a first confidence score and one or more other confidence scores, and each respective confidence score of the one or more other confidence scores may be represented by the first quantity of bits, whereas the first confidence score may be represented by the second quantity of bits.

In still another example, the information indicating the at least one quantity of bits may indicate that each respective confidence score of a set of confidence scores is to be represented by the first quantity of bits in the report, and where the report 836 includes information indicating a first predicted value and a second predicted value, the information indicating the at least one quantity of bits may indicate that the first predicted value is represented by the first quantity of bits in the report 836 and the second predicted value is represented by the second quantity of bits in the report 836.

Upon receiving the report 836, the base station 802 may determine a selected beam of the set of beams 812 based on the at least one confidence score 844 that is associated with the at least one predicted value 842. For example, the base station 802 may compare respective predicted values corresponding to each of the set of beams to one another to determine a highest or “best” predicted value corresponding to a first beam. The base station may compare the confidence score associated with the highest or “best” predicted value to a threshold, and if the confidence score satisfies (e.g., meets or exceeds) the threshold, then the base station 802 may select the first beam. Otherwise, the base station 802 may select another beam having a confidence score that satisfies the threshold.

The base station 802 may transmit a beam configuration 838 to the UE 804. The beam configuration 838 may indicate the selected beam to the UE 804. The UE 804 may receive the beam configuration and tune antenna panels or arrays in a direction that corresponds or is paired with that of the selected beam.

The base station 802 and the UE 804 may communicate 840 using the selected beam of the set of beams 812 that is based on the information indicating the at least one confidence score 844. For example, the base station 802 may transmit data and/or control information to the UE 804 via the selected beam.

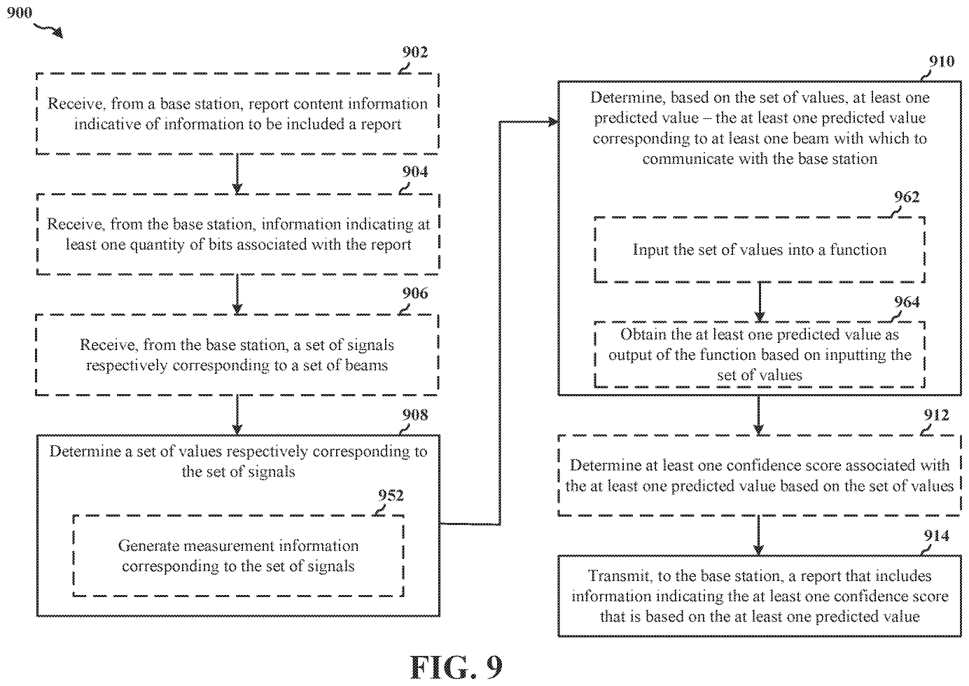

FIG. 9 is a flowchart of a method 900 of wireless communication. The method may be performed by or at a network node, such as a UE (e.g., the UE 104, 350), another wireless communications apparatus (e.g., the apparatus 1102), or one or more components thereof. According to various different aspects, one or more of the illustrated blocks may be omitted, transposed, and/or contemporaneously performed.

At 902, the UE may receive, from a base station, report content information indicative of information to be included a report. For example, the report content information may indicate that the report should include at least one value of a set of values is measured from at least one signal of a set of signals, a first indication that the at least one value of the set of values is measured, at least one predicted value that is based on at least one value of the set of values, and/or a second indication that the at least one predicted value corresponds to a prediction. In another example, the report content information indicative of information to be included in the report may indicate that at least one confidence score is to be included in the report.

For example, in the context of FIG. 8, the UE 804 may receive, from the base station 802, the reporting configuration 832 indicative of information to be included in the report 836.

At 904, the UE may receive, from the base station, information indicating at least one quantity of bits associated with the report. For example, the information indicating the at least one quantity of bits may indicate that a first quantity of bits is to be used to represent each confidence score of a set of confidence scores in the report. In another example, the information indicating the at least one quantity of bits may indicate a first quantity of bits and a second quantity of bits, and the first quantity of bits may be less than the second quantity of bits. Illustratively, a set of confidence scores may include a first confidence score and one or more other confidence scores, and each respective confidence score of the one or more other confidence scores is to be represented by the first quantity of bits, whereas the first confidence score is to be represented by the second quantity of bits.

In still another example, the information indicating the at least one quantity of bits may indicate that each respective confidence score of a set of confidence scores is to be represented by the first quantity of bits in the report, and where the report is to include information indicating a first predicted value and a second predicted value, the information indicating the at least one quantity of bits may indicate that the first predicted value is represented by the first quantity of bits in the report and the second predicted value is represented by the second quantity of bits in the report.

For example, in the context of FIG. 8, the UE 804 may receive, from the base station 802, the reporting configuration 832, which may indicate at least one quantity of bits associated with the report 836.

At 906, the UE may receive, from the base station, a set of signals respectively corresponding to a set of beams. For example, each of the signals may be an SSB or a CSI-RS transmitted on a respective beam of the set of beams.

For example, in the context of FIG. 8, the UE 804 may receive, from the base station 802, the set of signals 834 respectively corresponding to the set of base station beams 812.

At 908, the UE may determine a set of values respectively corresponding to the set of signals received from the base station. In various aspects, each of the set of values may be an RSRP value, an RSRQ value, an SNR value, an SINR value, a CQI value, or an RSSI value. The UE may be configured to identify a respective resource on which each of the set of signals is carried, and the UE may be configured to measure the energy or power on the identified respective resource, e.g., to obtain an RSRP value, and/or measure the energy or power on the identified respective resource that corresponds to one of the set of signals and subtract the measurement from the total energy or power on the identified respective resource, e.g., to obtain an SNR value.

For example, in the context of FIG. 8, the UE 804 may determine a set of actual values respectively corresponding to the set of signals 834 received from the base station 802.

At 952, in some aspects, to determine the set of values, the UE may be configured to generate measurement information corresponding to the set of signals. For example, the UE may generate a vector for each a plurality of time steps, and the UE may populate elements of each vector with measurements obtained based on the set of signals at a respective time step. In some aspects, the measurement information includes the determined set of values, whereas in some other aspects, the UE may process the measurement information resulting in the set of values.

For example, in the context of FIG. 8, to determine the at least one predicted value 842, the UE 804 may be configured to generate measurement information corresponding to the set of signals 834.

At 910, the UE may determine, based on the set of values respectively corresponding to the set of signals received from the base station, at least one predicted value, and the at least one predicted value may correspond to at least one beam with which to communicate with the base station. The at least one predicted value may be at least one predicted RSRP, at least one predicted RSRQ, at least one predicted SNR, at least one predicted SINR, at least one predicted CQI, or at least one predicted RSSI. In some aspects, the at least one predicted value may be a mean predicted value. In some aspects, the UE may predict a respective value at future time step for each measured value corresponding to one of the set of beams over each of a set of past time steps. The UE may plot a distribution of the respective values predicted for a future time step—e.g., the UE may plot a point for a predicted value at the future time step predicted from a measured value at past time step N−n+1, the UE may plot another point for another predicted value at the future time step predicted from another measured value at past time step N−n+2, and so forth. The UE may find the mean of the distribution of the plotted points, which may be the mean predicted value corresponding to the one of the set of beams at the future time step. In some aspects, the UE may determine the at least one predicted value further based on at least one of a battery status of the UE, a processor utilization of the UE, or a capability of the UE.

For example, in the context of FIG. 8, the UE 804 may determine, based on the set of values respectively corresponding to the set of signals 834 received from the base station 802, at least one predicted value 842, and the at least one predicted value 842 may correspond to at least one beam of the beams 812 with which to communicate with the base station 802.

At 962, to determine the at least one predicted value, the UE may input the set of values into a function. For example, the function may include at least one of a neural network, a deep-learning model, or a filter-based algorithm.

For example, in the context of FIG. 7, a UE may input the actual measurements 722 into the prediction function 700 having the model 720. For example, in the context of FIG. 8, the UE 804 may input the set of values into a function.

At 964, to determine the at least one predicted value, the UE may further obtain the at least one predicted value as output of the function based on inputting the set of values.

For example, in the context of FIG. 7, a UE may obtain the predicted values 724 as output of the prediction function 700 based on inputting the actual measurements 722 into the prediction function 700 having the model 720. For example, in the context of FIG. 8, the UE 804 may obtain the at least one predicted value 842 as output of the function based on inputting the set of values.

At 912, the UE may determine at least one confidence score based on the at least one predicted value. According to various aspects, the at least one confidence score may include at least one of a variance, a standard deviation, a probability, or a likelihood. The at least one confidence score may be indicative of reliability of the at least one predicted value. For example, the UE may predict a respective value at a future time step for each measured value corresponding to one of the set of beams over each of a set of past time steps. The UE may plot a distribution of the respective values predicted for the future time step—e.g., the UE may plot a point for a predicted value at the future time step predicted from a measured value at past time step N−n+1, the UE may plot another point for another predicted value at the future time step predicted from another measured value at past time step N−n+2, and so forth. The UE may find the standard deviation and/or the variance of the distribution of the plotted points, which may represent the confidence score of a corresponding mean predicted value at the future time step. In some aspects, the at least one confidence score may be based on at least one of a most recently predicted value corresponding to the at least one beam or a filtered over instantaneous predicted value corresponding to the at least one beam, and the at least one predicted value may include the most recently predicted value or the filter over instantaneous predicted value.

For example, in the context of FIG. 7, a UE may obtain the confidence scores 726 as output of the prediction function 700 based on inputting the actual measurements 722 into the prediction function 700 having the model 720. For example, in the context of FIG. 8, the UE 804 may obtain the at least one confidence score 844 corresponding to the at least one predicted value 842 as output of the function based on inputting the set of values.

At 914, the UE may transmit, to the base station, a report that includes information indicating the at least one confidence score that is based on the at least one predicted value. According to various aspects, the report may further include at least one of at least one of the set of values respectively corresponding to the set of signals transmitted by the base station, a first indication that the at least one of the set of values is measured, the at least one predicted value, or a second indication that the at least one predicted value corresponds to a prediction. In some aspects, the information indicating the at least one confidence score includes at least one quantized value that is based on the at least one confidence score. In some other aspects, the report includes a set of IDs respectively associated with each beam of the at least one beam that corresponds to a respective predicted value of the at least one predicted value that satisfies a threshold, and the set of IDs may be based on a respective confidence score of the at least one confidence score. In still other aspects, the report includes time information indicative of a respective time to which each respective confidence score of the at least one confidence score corresponds.

For example, in the context of FIG. 8, the UE 804 may transmit, to the base station 802, a report 836 that includes information indicating the at least one confidence score 844 that is associated with on the at least one predicted value 842.

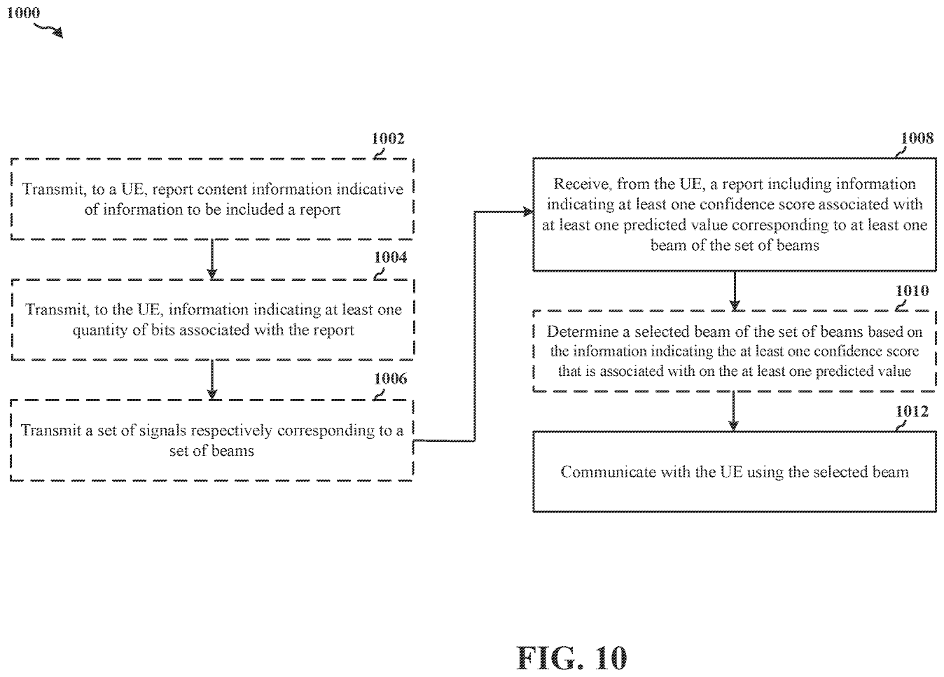

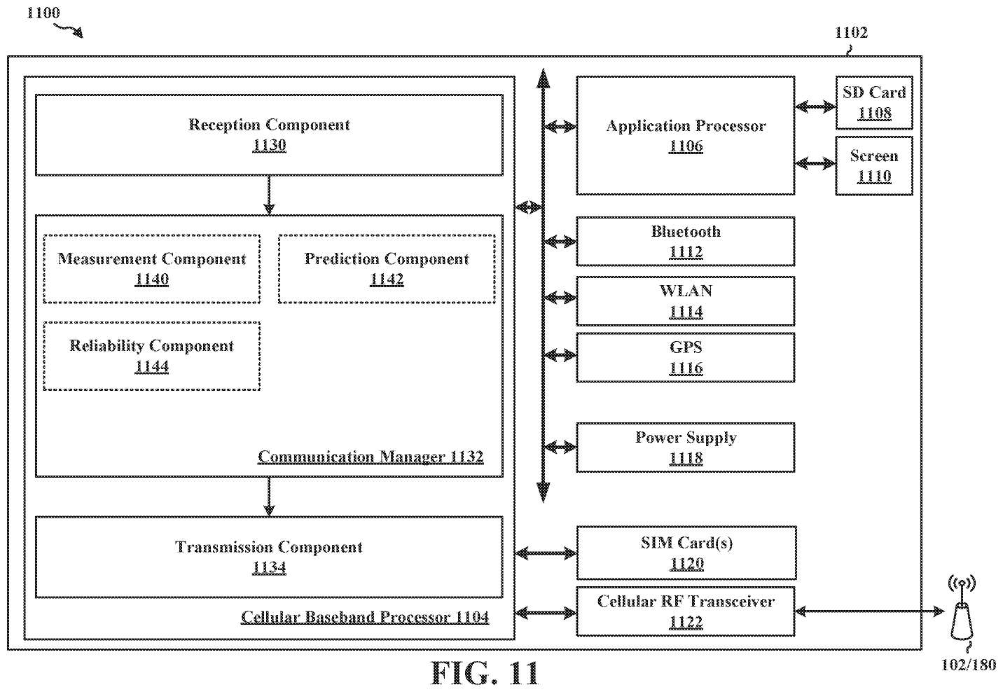

FIG. 10 is a flowchart of a method 1000 of wireless communication. The method may be performed by or at a network node, such as a base station (e.g., the base station 102/180, 310), another wireless communications apparatus (e.g., the apparatus 1202), or one or more components thereof. According to various different aspects, one or more of the illustrated blocks may be omitted, transposed, and/or contemporaneously performed.

At 1002, the base station may transmit, to a UE, report content information indicative of information to be included a report. For example, the report content information may indicate that the report should include at least one value of a set of values is measured from at least one signal of a set of signals, a first indication that the at least one value of the set of values is measured, at least one predicted value that is based on at least one value of the set of values, and/or a second indication that the at least one predicted value corresponds to a prediction. In another example, the report content information indicative of information to be included in the report may indicate that at least one confidence score is to be included in the report.

For example, in the context of FIG. 8, the base station 802 may transmit, to the UE 804, the reporting configuration 832 indicative of information to be included in the report 836.

At 1004, the base station may transmit, to the UE, information indicating at least one quantity of bits associated with the report. For example, the information indicating the at least one quantity of bits may indicate that a first quantity of bits is to be used to represent each confidence score of a set of confidence scores in the report. In another example, the information indicating the at least one quantity of bits may indicate a first quantity of bits and a second quantity of bits, and the first quantity of bits may be less than the second quantity of bits. Illustratively, a set of confidence scores may include a first confidence score and one or more other confidence scores, and each respective confidence score of the one or more other confidence scores is to be represented by the first quantity of bits, whereas the first confidence score is to be represented by the second quantity of bits.

In still another example, the information indicating the at least one quantity of bits may indicate that each respective confidence score of a set of confidence scores is to be represented by the first quantity of bits in the report, and where the report is to include information indicating a first predicted value and a second predicted value, the information indicating the at least one quantity of bits may indicate that the first predicted value is represented by the first quantity of bits in the report and the second predicted value is represented by the second quantity of bits in the report.

For example, in the context of FIG. 8, the base station 802 may transmit, to the UE 804, the reporting configuration 832, which may indicate at least one quantity of bits associated with the report 836.

At 1006, the base station may transmit, to the UE, a set of signals respectively corresponding to a set of beams. For example, each of the signals may be an SSB or a CSI-RS transmitted on a respective beam of the set of beams.

For example, in the context of FIG. 8, the base station 802 may transmit, to the UE 804, the set of signals 834 respectively corresponding to the set of base station beams 812.

At 1008, the base station may receive, from the UE, a report including information indicating at least one confidence score associated with at least one predicted value corresponding to at least one beam of the set of beams. The confidence score may be at least one of a variance, a standard deviation, a probability, or a likelihood. The confidence score may be indicative of reliability of the at least one predicted value. According to various aspects, the report may further include at least one of at least one of a set of values respectively corresponding to the set of signals transmitted by the base station, a first indication that the at least one of the set of values is measured, the at least one predicted value, or a second indication that the at least one predicted value corresponds to a prediction. In some aspects, the information indicating the at least one confidence score includes at least one quantized value that is based on the at least one confidence score. In some other aspects, the report includes a set of IDs respectively associated with each beam of a set of beams that corresponds to a respective predicted value of the at least one predicted value that satisfies a threshold, and the set of IDs may be based on a respective confidence score of the at least one confidence score. In still other aspects, the report includes time information indicative of a respective time to which each respective confidence score of the at least one confidence score corresponds. In yet other aspects, the information indicating the at least one confidence score is based on at least one of a most recently predicted value corresponding to the at least one beam or a filtered over instantaneous predicted value corresponding to the at least one beam, and the at least one predicted value includes the most recently predicted value or the filter over instantaneous predicted value.

For example, in the context of FIG. 8, the base station 802 may receive, from the UE 804, a report 836 that includes information indicating the at least one confidence score 844 that is associated with on the at least one predicted value 842.

At 1010, the base station may determine a selected beam of the set of beams based on the at least one predicted value and based on the at least one confidence score. For example, the base station may compare respective predicted values corresponding to each of the set of beams to one another to determine a highest or “best” predicted value corresponding to a first beam. The base station may compare the confidence score associated with the highest or “best” predicted value to a threshold, and if the confidence score satisfies (e.g., meets or exceeds) the threshold, then the base station may select the first beam. Otherwise, the base station may select another beam having a confidence score that satisfies the threshold.

For example, in the context of FIG. 8, the base station 802 may determine a selected beam of the set of beams 812 based on the information indicating the at least one confidence score 844 that is associated with on the at least one predicted value 842.

At 1012, the base station may communicate with the UE using the selected beam that is based on the information indicating the at least one confidence score. For example, the base station may transmit data and/or control information to the UE via the selected beam.

For example, in the context of FIG. 8, the base station 802 may communicate 840 with the UE 804 using the selected beam of the set of beams 812 that is based on the information indicating the at least one confidence score 844.

FIG. 11 is a diagram 1100 illustrating an example of a hardware implementation for an apparatus 1102. The apparatus 1102 may be a UE or similar device, or the apparatus 1102 may be a component of a UE or similar device. The apparatus 1102 may include a cellular baseband processor 1104 (also referred to as a modem) and/or a cellular RF transceiver 1122, which may be coupled together and/or integrated into the same package, component, circuit, chip, and/or other circuitry.

In some aspects, the apparatus 1102 may accept or may include one or more subscriber identity modules (SIM) cards 1120, which may include one or more integrated circuits, chips, or similar circuitry, and which may be removable or embedded. The one or more SIM cards 1120 may carry identification and/or authentication information, such as an international mobile subscriber identity (IMSI) and/or IMSI-related key(s). Further, the apparatus 1102 may include one or more of an application processor 1106 coupled to a secure digital (SD) card 1108 and a screen 1110, a Bluetooth module 1112, a wireless local area network (WLAN) module 1114, a Global Positioning System (GPS) module 1116, and/or a power supply 1118.

The cellular baseband processor 1104 communicates through the cellular RF transceiver 1122 with the UE 104 and/or base station 102/180. The cellular baseband processor 1104 may include a computer-readable medium/memory. The computer-readable medium/memory may be non-transitory. The cellular baseband processor 1104 is responsible for general processing, including the execution of software stored on the computer-readable medium/memory. The software, when executed by the cellular baseband processor 1104, causes the cellular baseband processor 1104 to perform the various functions described supra. The computer-readable medium/memory may also be used for storing data that is manipulated by the cellular baseband processor 1104 when executing software. The cellular baseband processor 1104 further includes a reception component 1130, a communication manager 1132, and a transmission component 1134. The communication manager 1132 includes the one or more illustrated components. The components within the communication manager 1132 may be stored in the computer-readable medium/memory and/or configured as hardware within the cellular baseband processor 1104.

In the context of FIG. 3, the cellular baseband processor 1104 may be a component of the UE 350 and may include the memory 360 and/or at least one of the TX processor 368, the RX processor 356, and/or the controller/processor 359. In one configuration, the apparatus 1102 may be a modem chip and/or may be implemented as the baseband processor 1104, while in another configuration, the apparatus 1102 may be the entire UE (e.g., the UE 350 of FIG. 3) and may include some or all of the abovementioned components, circuits, chips, and/or other circuitry illustrated in the context of the apparatus 1102. In one configuration, the cellular RF transceiver 1122 may be implemented as at least one of the transmitter 354TX and/or the receiver 354RX.

The reception component 1130 may be configured to receive signaling on a wireless channel, such as signaling from a base station 102/180 or UE 104. The transmission component 1134 may be configured to transmit signaling on a wireless channel, such as signaling to a base station 102/180 or UE 104. The communication manager 1132 may coordinate or manage some or all wireless communications by the apparatus 1102, including across the reception component 1130 and the transmission component 1134.

The reception component 1130 may provide some or all data and/or control information included in received signaling to the communication manager 1132, and the communication manager 1132 may generate and provide some or all of the data and/or control information to be included in transmitted signaling to the transmission component 1134. The communication manager 1132 may include the various illustrated components, including one or more components configured to process received data and/or control information, and/or one or more components configured to generate data and/or control information for transmission.

The reception component 1130 may be configured to receive, from a base station 102/180, report content information indicative of information to be included a report, e.g., as described in connection with 902 of FIG. 9. For example, the report content information may indicate that the report should include at least one value of a set of values is measured from at least one signal of a set of signals, a first indication that the at least one value of the set of values is measured, at least one predicted value that is based on at least one value of the set of values, and/or a second indication that the at least one predicted value corresponds to a prediction. In another example, the report content information indicative of information to be included in the report may indicate that at least one confidence score is to be included in the report.

The reception component 1130 may be further configured to receive, from the base station 102/180, information indicating at least one quantity of bits associated with the report, e.g., as described in connection with 904 of FIG. 9. For example, the information indicating the at least one quantity of bits may indicate that a first quantity of bits is to be used to represent each confidence score of a set of confidence scores in the report. In another example, the information indicating the at least one quantity of bits may indicate a first quantity of bits and a second quantity of bits, and the first quantity of bits may be less than the second quantity of bits. Illustratively, a set of confidence scores may include a first confidence score and one or more other confidence scores, and each respective confidence score of the one or more other confidence scores is to be represented by the first quantity of bits, whereas the first confidence score is to be represented by the second quantity of bits.

In still another example, the information indicating the at least one quantity of bits may indicate that each respective confidence score of a set of confidence scores is to be represented by the first quantity of bits in the report, and where the report is to include information indicating a first predicted value and a second predicted value, the information indicating the at least one quantity of bits may indicate that the first predicted value is represented by the first quantity of bits in the report and the second predicted value is represented by the second quantity of bits in the report.

The reception component 1130 may be further configured to receive, from the base station 102/180, a set of signals respectively corresponding to a set of beams, e.g., as described in connection with 906 of FIG. 9. For example, each of the signals may be an SSB or a CSI-RS transmitted on a respective beam of the set of beams.

A measurement component 1140 may be configured to determine a set of values respectively corresponding to the set of signals received from the base station 102/180, e.g., as described in connection with 908 of FIG. 9. In various aspects, each of the set of values may be an RSRP value, an RSRQ value, an SNR value, an SINR value, a CQI value, or an RSSI value. The measurement component 1140 may be configured to identify a respective resource on which each of the set of signals is carried, and the measurement component 1140 may be configured to measure the energy or power on the identified respective resource, e.g., to obtain an RSRP value, and/or measure the energy or power on the identified respective resource that corresponds to one of the set of signals and subtract the measurement from the total energy or power on the identified respective resource, e.g., to obtain an SNR value.

In some aspects, to determine the set of values, the measurement component 1140 may be configured to generate measurement information corresponding to the set of signals, e.g., as described in connection with 952 of FIG. 9. For example, the measurement component 1140 may generate a vector for each a plurality of time steps, and the measurement component 1140 may populate elements of each vector with measurements obtained based on the set of signals at a respective time step. In some aspects, the measurement information includes the determined set of values, whereas in some other aspects, the measurement component 1140 may process the measurement information resulting in the set of values.

A prediction component 1142 may be configured to determine, based on the set of values respectively corresponding to the set of signals received from the base station 102/180, at least one predicted value, and the at least one predicted value may correspond to at least one beam with which to communicate with the base station 102/180, e.g., as described in connection with 910 of FIG. 9. The at least one predicted value may be at least one predicted RSRP, at least one predicted RSRQ, at least one predicted SNR, at least one predicted SINR, at least one predicted CQI, or at least one predicted RSSI. In some aspects, the at least one predicted value may be a mean predicted value. In some aspects, the prediction component 1142 may predict a respective value at future time step for each measured value corresponding to one of the set of beams over each of a set of past time steps. The prediction component 1142 may plot a distribution of the respective values predicted for a future time step—e.g., the prediction component 1142 may plot a point for a predicted value at the future time step predicted from a measured value at past time step N−n+1, the prediction component 1142 may plot another point for another predicted value at the future time step predicted from another measured value at past time step N−n+2, and so forth. The prediction component 1142 may find the mean of the distribution of the plotted points, which may be the mean predicted value corresponding to the one of the set of beams at the future time step. In some aspects, the prediction component 1142 may determine the at least one predicted value further based on at least one of a battery status of the apparatus 1102, a processor utilization of the apparatus 1102, or a capability of the apparatus 1102.

In some aspects, to determine the at least one predicted value, the prediction component 1142 may input the set of values into a function, e.g., as described in connection with 962 of FIG. 9. For example, the function may include at least one of a neural network, a deep-learning model, or a filter-based algorithm.

Further, to determine the at least one predicted value, the prediction component 1142 may further obtain the at least one predicted value as output of the function based on inputting the set of values, e.g., as described in connection with 964 of FIG. 9.

A reliability component 1144 may be configured to determine at least one confidence score based on the at least one predicted value, e.g., as described in connection with 912 of FIG. 9. According to various aspects, the at least one confidence score may include at least one of a variance, a standard deviation, a probability, or a likelihood. The at least one confidence score may be indicative of reliability of the at least one predicted value. For example, the prediction component 1142 may predict a respective value at a future time step for each measured value corresponding to one of the set of beams over each of a set of past time steps. The prediction component 1142 may plot a distribution of the respective values predicted for the future time step—e.g., the prediction component 1142 may plot a point for a predicted value at the future time step predicted from a measured value at past time step N−n+1, the prediction component 1142 may plot another point for another predicted value at the future time step predicted from another measured value at past time step N−n+2, and so forth. The reliability component 1144 may find the standard deviation and/or the variance of the distribution of the plotted points, which may represent the confidence score of a corresponding mean predicted value at the future time step. In some aspects, the at least one confidence score may be based on at least one of a most recently predicted value corresponding to the at least one beam or a filtered over instantaneous predicted value corresponding to the at least one beam, and the at least one predicted value may include the most recently predicted value or the filter over instantaneous predicted value.

The transmission component may be configured to transmit, to the base station 102/180, a report that includes information indicating the at least one confidence score that is based on the at least one predicted value, e.g., as described in connection with 914 of FIG. 9. According to various aspects, the report may further include at least one of at least one of the set of values respectively corresponding to the set of signals transmitted by the base station 102/180, a first indication that the at least one of the set of values is measured, the at least one predicted value, or a second indication that the at least one predicted value corresponds to a prediction. In some aspects, the information indicating the at least one confidence score includes at least one quantized value that is based on the at least one confidence score. In some other aspects, the report includes a set of IDs respectively associated with each beam of the at least one beam that corresponds to a respective predicted value of the at least one predicted value that satisfies a threshold, and the set of IDs may be based on a respective confidence score of the at least one confidence score. In still other aspects, the report includes time information indicative of a respective time to which each respective confidence score of the at least one confidence score corresponds.

The apparatus 1102 may include additional components that perform some or all of the blocks, operations, signaling, etc. of the algorithm(s) in the aforementioned call flow diagram and/or flowchart of FIGS. 8 and 9. As such, some or all of the blocks, operations, signaling, etc. in the aforementioned call flow diagram and/or flowchart of FIGS. 8 and 9 may be performed by one or more components and the apparatus 1102 may include one or more such components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1102, and in particular the cellular baseband processor 1104, includes means for determining a set of values respectively corresponding to a set of signals received from a base station, wherein the set of signals corresponds to a set of beams; means for determining, based on the set of values, at least one predicted value, wherein the at least one predicted value corresponds to at least one beam with which to communicate with the base station; and means for transmitting, to the base station, a report, wherein the report includes information indicating at least one confidence score that is associated with the at least one predicted value.

In one configuration, the means for determining the set of values respectively corresponding to the set of signals is configured to generate measurement information corresponding to the set of signals, wherein the measurement information includes the set of values, or the set of values results from processing the measurement information.

In one configuration, each respective value of the set of values corresponds to a respective RSRP, and the at least one predicted value corresponds to at least one predicted RSRP.

In one configuration, the at least one predicted RSRP comprises a predicted mean RSRP.

In one configuration, each value of the set of values respectively corresponds to an RSRP, an SNR, an SINR, an RSRQ, a CQI, or an RSSI.

In one configuration, the at least one predicted value comprises a predicted mean value corresponding to at least one of an RSRP, an SNR, an SINR, an RSRQ, a CQI, or an RSSI.

In one configuration, the apparatus 1102, and in particular the cellular baseband processor 1104, further includes means for determining the at least one confidence score associated with the at least one predicted value.

In one configuration, the at least one confidence score comprises at least one of a variance, a standard deviation, a probability, or a likelihood.

In one configuration, the at least one confidence score is indicative of reliability of the at least one predicted value.

In one configuration, the information indicating the at least one confidence score comprises at least one quantized value that is based on the at least one confidence score.

In one configuration, the report includes a set of IDs respectively associated with each beam of the at least one beam that corresponds to a respective predicted value of the at least one predicted value that satisfies a threshold, wherein the set of IDs are based on a respective confidence score of the at least one confidence score.

In one configuration, the apparatus 1102, and in particular the cellular baseband processor 1104, further includes means for receiving, from the base station, information indicating at least one quantity of bits.

In one configuration, the at least one quantity of bits includes a first quantity of bits, and wherein each respective confidence score of the at least one confidence score is represented by the first quantity of bits in the information indicating the at least one confidence score.

In one configuration, the at least one quantity of bits includes a first quantity of bits and a second quantity of bits, wherein the first quantity of bits is less than the second quantity of bits.

In one configuration, the at least one confidence score includes a first confidence score and one or more other confidence scores, wherein each respective confidence score of the one or more other confidence scores is represented by the first quantity of bits in the information indicating the at least one confidence score, and wherein the first confidence score is represented by the second quantity of bits in the information indicating the at least one confidence score.

In one configuration, each respective confidence score of the at least one confidence score is represented by the first quantity of bits in the information indicating the at least one confidence score, wherein the report includes information indicating a first predicted value of the at least one predicted value and a second predicted value of the at least one predicted value, wherein the first predicted value is represented by the first quantity of bits in the information indicating the first predicted value, and wherein the second predicted value is represented by the second quantity of bits in the information indicating the second predicted value.

In one configuration, the report includes at least one of: at least one value of the set of values, a first indication that the at least one value of the set of values is measured, the at least one predicted value, or a second indication that the at least one predicted value corresponds to a prediction.

In one configuration, the apparatus 1102, and in particular the cellular baseband processor 1104, further includes means for receiving, from the base station, report content information indicative of information to be included the report, wherein at least one of the first indication or the second indication is based on the report content information.

In one configuration, the at least one confidence score is based on at least one of a most recently predicted value corresponding to the at least one beam or a filtered over instantaneous predicted value corresponding to the at least one beam, wherein the at least one predicted value includes the most recently predicted value or the filtered over instantaneous predicted value.

In one configuration, the report includes time information indicative of a respective time to which each respective confidence score of the at least one confidence score corresponds.

In one configuration, the means for determining the at least one predicted value is configured to: input the set of values into a function; and obtain the at least one predicted value as output of the function based on inputting the set of values.

In one configuration, the function comprises at least one of a neural network, a deep-learning model, or a filter-based algorithm.

In one configuration, the means for determining the at least one predicted value is configured to determine the at least one predicted value based on at least one of a battery status of the UE, a processor utilization of the UE, or a capability of the UE.

In one configuration, the apparatus 1102, and in particular the cellular baseband processor 1104, further includes means for receiving, from the base station, report content information indicative of information to be included the report, wherein the report includes, based on the report content information, the information indicating the at least one confidence score.

The aforementioned means may be one or more of the aforementioned components of the apparatus 1102 configured to perform the functions recited by the aforementioned means. As described supra, the apparatus 1102 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

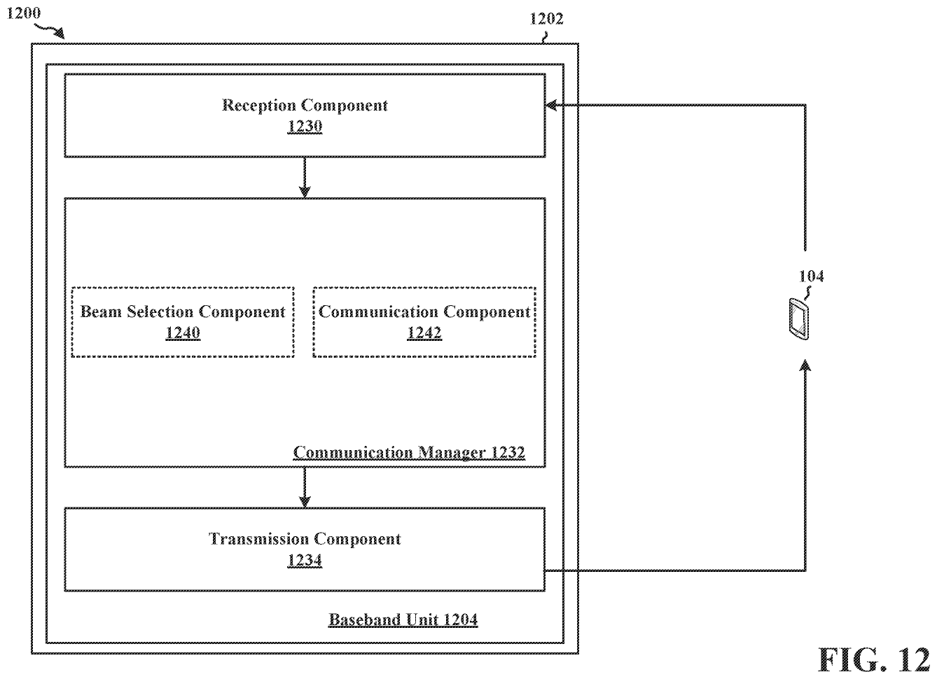

FIG. 12 is a diagram 1200 illustrating an example of a hardware implementation for an apparatus 1202. The apparatus 1202 may be a base station or similar device or system, or the apparatus 1202 may be a component of a base station or similar device or system. The apparatus 1202 may include a baseband unit 1204. The baseband unit 1204 may communicate through a cellular RF transceiver. For example, the baseband unit 1204 may communicate through a cellular RF transceiver with a UE 104, such as for downlink and/or uplink communication, and/or with a base station 102/180, such as for IAB.

The baseband unit 1204 may include a computer-readable medium/memory, which may be non-transitory. The baseband unit 1204 is responsible for general processing, including the execution of software stored on the computer-readable medium/memory. The software, when executed by the baseband unit 1204, causes the baseband unit 1204 to perform the various functions described supra. The computer-readable medium/memory may also be used for storing data that is manipulated by the baseband unit 1204 when executing software. The baseband unit 1204 further includes a reception component 1230, a communication manager 1232, and a transmission component 1234. The communication manager 1232 includes the one or more illustrated components. The components within the communication manager 1232 may be stored in the computer-readable medium/memory and/or configured as hardware within the baseband unit 1204. The baseband unit 1204 may be a component of the base station 310 and may include the memory 376 and/or at least one of the TX processor 316, the RX processor 370, and the controller/processor 375.

The reception component 1230 may be configured to receive signaling on a wireless channel, such as signaling from a UE 104 or base station 102/180. The transmission component 1234 may be configured to transmit signaling on a wireless channel, such as signaling to a UE 104 or base station 102/180. The communication manager 1232 may coordinate or manage some or all wireless communications by the apparatus 1202, including across the reception component 1230 and the transmission component 1234.

The reception component 1230 may provide some or all data and/or control information included in received signaling to the communication manager 1232, and the communication manager 1232 may generate and provide some or all of the data and/or control information to be included in transmitted signaling to the transmission component 1234. The communication manager 1232 may include the various illustrated components, including one or more components configured to process received data and/or control information, and/or one or more components configured to generate data and/or control information for transmission. In some aspects, the generation of data and/or control information may include packetizing or otherwise reformatting data and/or control information received from a core network, such as the core network 190 or the EPC 160, for transmission.

The communication manager 1232 may include a beam selection component 1240 and a communication component 1242.

The transmission component 1234 may be configured to transmit, to a UE 104, report content information indicative of information to be included a report, e.g., as described in connection with 1002 of FIG. 10. For example, the report content information may indicate that the report should include at least one value of a set of values is measured from at least one signal of a set of signals, a first indication that the at least one value of the set of values is measured, at least one predicted value that is based on at least one value of the set of values, and/or a second indication that the at least one predicted value corresponds to a prediction. In another example, the report content information indicative of information to be included in the report may indicate that at least one confidence score is to be included in the report.

The transmission component 1234 may be configured to transmit, to the UE 104, information indicating at least one quantity of bits associated with the report, e.g., as described in connection with 1004 of FIG. 10. For example, the information indicating the at least one quantity of bits may indicate that a first quantity of bits is to be used to represent each confidence score of a set of confidence scores in the report. In another example, the information indicating the at least one quantity of bits may indicate a first quantity of bits and a second quantity of bits, and the first quantity of bits may be less than the second quantity of bits. Illustratively, a set of confidence scores may include a first confidence score and one or more other confidence scores, and each respective confidence score of the one or more other confidence scores is to be represented by the first quantity of bits, whereas the first confidence score is to be represented by the second quantity of bits.

In still another example, the information indicating the at least one quantity of bits may indicate that each respective confidence score of a set of confidence scores is to be represented by the first quantity of bits in the report, and where the report is to include information indicating a first predicted value and a second predicted value, the information indicating the at least one quantity of bits may indicate that the first predicted value is represented by the first quantity of bits in the report and the second predicted value is represented by the second quantity of bits in the report.

The transmission component 1234 may be configured to transmit, to the UE 104, a set of signals respectively corresponding to a set of beams, e.g., as described in connection with 1006 of FIG. 10. For example, each of the signals may be an SSB or a CSI-RS transmitted on a respective beam of the set of beams.

The reception component 1230 may be configured to receive, from the UE 104, a report including information indicating at least one confidence score associated with at least one predicted value corresponding to at least one beam of the set of beams, e.g., as described in connection with 1008 of FIG. 10. The confidence score may be at least one of a variance, a standard deviation, a probability, or a likelihood. The confidence score may be indicative of reliability of the at least one predicted value. According to various aspects, the report may further include at least one of at least one of a set of values respectively corresponding to the set of signals transmitted by the transmission component 1234, a first indication that the at least one of the set of values is measured, the at least one predicted value, or a second indication that the at least one predicted value corresponds to a prediction. In some aspects, the information indicating the at least one confidence score includes at least one quantized value that is based on the at least one confidence score. In some other aspects, the report includes a set of IDs respectively associated with each beam of a set of beams that corresponds to a respective predicted value of the at least one predicted value that satisfies a threshold, and the set of IDs may be based on a respective confidence score of the at least one confidence score. In still other aspects, the report includes time information indicative of a respective time to which each respective confidence score of the at least one confidence score corresponds. In yet other aspects, the information indicating the at least one confidence score is based on at least one of a most recently predicted value corresponding to the at least one beam or a filtered over instantaneous predicted value corresponding to the at least one beam, and the at least one predicted value includes the most recently predicted value or the filter over instantaneous predicted value.

The beam selection component 1240 may be configured to determine a selected beam of the set of beams based on the at least one predicted value and based on the at least one confidence score, e.g., as described in connection with 1010 of FIG. 10. For example, the beam selection component 1240 may compare respective predicted values corresponding to each of the set of beams to one another to determine a highest or “best” predicted value corresponding to a first beam. The beam selection component 1240 may compare the confidence score associated with the highest or “best” predicted value to a threshold, and if the confidence score satisfies (e.g., meets or exceeds) the threshold, then the beam selection component 1240 may select the first beam. Otherwise, the beam selection component 1240 may select another beam having a confidence score that satisfies the threshold.

The communication component 1242 may be configured to communicate with the UE 104 using the selected beam that is based on the information indicating the at least one confidence score, e.g., as described in connection with 1012 of FIG. 10. For example, the transmission component 1234 may transmit data and/or control information to the UE 104 via the selected beam.

In one configuration, the apparatus 1202, and in particular the baseband unit 1204, includes means for receiving, from a UE, a report including information indicating at least one confidence score associated with at least one predicted value corresponding to at least one beam with which to communicate with the UE; and means for communicating with the UE using a selected beam that is based on the information indicating the at least one confidence score.

In one configuration, the apparatus 1202, and in particular the baseband unit 1204, includes means for transmitting, to the UE, information configuring the UE to report the information indicating at least one confidence score, wherein the report is received based on the information configuring the UE to report the information indicating the at least one confidence score.

In one configuration, the report further comprises at least one of at least one of a set of values respectively corresponding to a set of signals transmitted by the method, wherein the set of signals corresponds to a set of beams, a first indication that the at least one of the set of values is measured, the at least one predicted value, or a second indication that the at least one predicted value corresponds to a prediction.

In one configuration, the apparatus 1202, and in particular the baseband unit 1204, includes means for transmitting, to the UE, report content information indicative of information to be included the report, wherein at least one of the first indication or the second indication is based on the report content information.

In one configuration, the at least one of the set of values corresponds to an RSRP, an SNR, an SINR, an RSRQ, a CQI, or an RSSI.

In one configuration, the at least one predicted value comprises a predicted mean value corresponding to at least one of: an RSRP, an SNR, an SINR, an RSRQ, a CQI, or an RSSI.

In one configuration, the at least one confidence score comprises at least one of a variance, a standard deviation, a probability, or a likelihood.

In one configuration, the confidence score is indicative of reliability of the at least one predicted value.

In one configuration, the information indicating the at least one confidence score comprises at least one quantized value that is based on the at least one confidence score.

In one configuration, the report includes a set of identifiers (IDs) respectively associated with each beam of the at least one beam that corresponds to a respective predicted value of the at least one predicted value that satisfies a threshold, wherein the set of IDs are based on a respective confidence score of the at least one confidence score.

In one configuration, the apparatus 1202, and in particular the baseband unit 1204, includes means for transmitting, to the UE, information indicating at least one quantity of bits for reporting the information indicating the at least one confidence score.

In one configuration, the at least one quantity of bits includes a first quantity of bits, and wherein each respective confidence score of the at least one confidence score is represented by the first quantity of bits in the information indicating the at least one confidence score.

In one configuration, the at least one quantity of bits includes a first quantity of bits and a second quantity of bits, wherein the first quantity of bits is less than the second quantity of bits.

In one configuration, the at least one confidence score includes a first confidence score and one or more other confidence scores, wherein each respective confidence score of the one or more other confidence scores is represented by the first quantity of bits in the information indicating the at least one confidence score, and wherein the first confidence score is represented by the second quantity of bits in the information indicating the at least one confidence score.

In one configuration, wherein each respective confidence score of the at least one confidence score is represented by the first quantity of bits in the information indicating the at least one confidence score, wherein the report includes information indicating a first predicted value of the at least one predicted value and a second predicted value of the at least one predicted value, wherein the first predicted value is represented by the first quantity of bits in the information indicating the first predicted value, and wherein the second predicted value is represented by the second quantity of bits in the information indicating the second predicted value.

In one configuration, the at least one confidence score is based on at least one of a most recently predicted value corresponding to the at least one beam or a filtered over instantaneous predicted value corresponding to the at least one beam, wherein the at least one predicted value includes the most recently predicted value or the filtered over instantaneous predicted value.

In one configuration, the report includes time information indicative of a respective time to which each respective confidence score of the at least one confidence score corresponds.

In one configuration, the apparatus 1202, and in particular the baseband unit 1204, includes means for determining the selected beam of the set of beams based on the information indicating the at least one confidence score that is associated with on the at least one predicted value.

The apparatus 1202 may include additional components that perform some or all of the blocks, operations, signaling, etc. of the algorithm(s) in the aforementioned call flow diagram and/or flowchart of FIGS. 8 and 10. As such, some or all of the blocks, operations, signaling, etc. in the aforementioned call flow diagram and/or flowchart of FIGS. 8 and 10 may be performed by a component and the apparatus 1202 may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

The aforementioned means may be one or more of the aforementioned components of the apparatus 1202 configured to perform the functions recited by the aforementioned means. As described supra, the apparatus 1202 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

The specific order or hierarchy of blocks or operations in each of the foregoing processes, flowcharts, and other diagrams disclosed herein is an illustration of example approaches. Based upon design preferences, the specific order or hierarchy of blocks or operations in each of the processes, flowcharts, and other diagrams may be rearranged, omitted, and/or contemporaneously performed without departing from the scope of the present disclosure. Further, some blocks or operations may be combined or omitted. The accompanying method claims present elements of the various blocks or operations in a sample order, and are not meant to be limited to the specific order or hierarchy presented.

The following clauses represent various examples of the techniques of this disclosure. These clauses are illustrative only and may be combined with aspects of other embodiments or teachings described herein, without limitation.

Clause 1 is a method of wireless communication at a UE, including: determining a set of values respectively corresponding to a set of signals received from a base station, and the set of signals corresponds to a set of beams; determining, based on the set of values, at least one predicted value, and the at least one predicted value corresponds to at least one beam with which to communicate with the base station; and transmitting, to the base station, a report, and the report includes information indicating at least one confidence score that is associated with the at least one predicted value.

Clause 2 is the method of clause 1, and determining the set of values respectively corresponding to the set of signals includes: generating measurement information corresponding to the set of signals, and the measurement information includes the set of values; or the set of values results from processing the measurement information.

Clause 3 is the method of any of clauses 1 to 2, and each respective value of the set of values corresponds to a respective RSRP, and the at least one predicted value corresponds to at least one predicted RSRP.

Clause 4 is the method of clause 3, and the at least one predicted RSRP includes a predicted mean RSRP.

Clause 5 is the method of any of clauses 1 to 4, and each value of the set of values respectively corresponds to an RSRP, an SNR, an SINR, an RSRQ, a CQI, or an RSSI.

Clause 6 is the method of any of clauses 1 to 5, and the at least one predicted value includes a predicted mean value corresponding to at least one of an RSRP, an SNR, an SINR, an RSRQ, a CQI, or an RSSI.

Clause 7 is the method of any of clauses 1 to 6, further including: determining the at least one confidence score associated with the at least one predicted value.

Clause 8 is the method of any of clauses 1 to 7, and the at least one confidence score includes at least one of a variance, a standard deviation, a probability, or a likelihood.

Clause 9 is the method of any of clauses 1 to 8, and the at least one confidence score is indicative of reliability of the at least one predicted value.

Clause 10 is the method of any of clauses 1 to 9, and the information indicating the at least one confidence score includes at least one quantized value that is based on the at least one confidence score.

Clause 11 is the method of any of clauses 1 to 10, and the report includes a set of IDs respectively associated with each beam of the at least one beam that corresponds to a respective predicted value of the at least one predicted value that satisfies a threshold, and the set of IDs are based on a respective confidence score of the at least one confidence score.

Clause 12 is the method of any of clauses 1 to 11, further including: receiving, from the base station, information indicating at least one quantity of bits.

Clause 13 is the method of clause 12, and the at least one quantity of bits includes a first quantity of bits, and each respective confidence score of the at least one confidence score is represented by the first quantity of bits in the information indicating the at least one confidence score.

Clause 14 is the method of clause 12, and the at least one quantity of bits includes a first quantity of bits and a second quantity of bits, and the first quantity of bits is less than the second quantity of bits.

Clause 15 is the method of clause 14, and the at least one confidence score includes a first confidence score and one or more other confidence scores, and each respective confidence score of the one or more other confidence scores is represented by the first quantity of bits in the information indicating the at least one confidence score, and the first confidence score is represented by the second quantity of bits in the information indicating the at least one confidence score.

Clause 16 is the method of clause 14, and each respective confidence score of the at least one confidence score is represented by the first quantity of bits in the information indicating the at least one confidence score, and the report includes information indicating a first predicted value of the at least one predicted value and a second predicted value of the at least one predicted value, and the first predicted value is represented by the first quantity of bits in the information indicating the first predicted value, and the second predicted value is represented by the second quantity of bits in the information indicating the second predicted value.

Clause 17 is the method of any of clauses 1 to 16, and the report includes at least one of: at least one value of the set of values, a first indication that the at least one value of the set of values is measured, the at least one predicted value, or a second indication that the at least one predicted value corresponds to a prediction.

Clause 18 is the method of clause 17, further including: receiving, from the base station, report content information indicative of information to be included the report, and at least one of the first indication or the second indication is based on the report content information.

Clause 19 is the method of any of clauses 1 to 18, and the at least one confidence score is based on at least one of a most recently predicted value corresponding to the at least one beam or a filtered over instantaneous predicted value corresponding to the at least one beam, and the at least one predicted value includes the most recently predicted value or the filtered over instantaneous predicted value.

Clause 20 is the method of any of clauses 1 to 19, and the report includes time information indicative of a respective time to which each respective confidence score of the at least one confidence score corresponds.

Clause 21 is the method of any of clauses 1 to 20, and determining the at least one predicted value includes: inputting the set of values into a function; and obtaining the at least one predicted value as output of the function based on inputting the set of values.

Clause 22 is the method of clause 21, and the function includes at least one of a neural network, a deep-learning model, or a filter-based algorithm.

Clause 23 is the method of any of clauses 1 to 22, and determining the at least one predicted value includes: determining the at least one predicted value based on at least one of a battery status of the UE, a processor utilization of the UE, or a capability of the UE.

Clause 24 is the method of any of clauses 1 to 23, further including: receiving, from the base station, report content information indicative of information to be included the report, and the report includes, based on the report content information, the information indicating the at least one confidence score.

Clause 25 is a method of wireless communication at a base station, including: receiving, from a second network node, a report including information indicating at least one confidence score associated with at least one predicted value corresponding to at least one beam with which to communicate with the second network node; and communicating with the second network node using a selected beam that is based on the information indicating the at least one confidence score.

Clause 26 is the method of clause 25, further including: transmitting, to the second network node, information configuring the second network node to report the information indicating at least one confidence score, and the report is received based on the information configuring the second network node to report the information indicating the at least one confidence score.

Clause 27 is the method of any of clauses 25 to 26, and the report further includes at least one of: at least one of a set of values respectively corresponding to a set of signals transmitted by the method, and the set of signals corresponds to a set of beams, a first indication that the at least one of the set of values is measured, the at least one predicted value, or a second indication that the at least one predicted value corresponds to a prediction.

Clause 28 is the method of clause 27, further including: transmitting, to the second network node, report content information indicative of information to be included the report, and at least one of the first indication or the second indication is based on the report content information.

Clause 29 is the method of clause 27, and the at least one of the set of values corresponds to an RSRP, an SNR, an SINR, an RSRQ, a CQI, or an RSSI.

Clause 30 is the method of clause 27, and the at least one predicted value includes a predicted mean value corresponding to at least one of an RSRP, an SNR, an SINR, an RSRQ, a CQI, or an RSSI.

Clause 31 is the method of any of clauses 25 to 30, and the at least one confidence score includes at least one of a variance, a standard deviation, a probability, or a likelihood.

Clause 32 is the method of any of clauses 25 to 31, and the confidence score is indicative of reliability of the at least one predicted value.

Clause 33 is the method of any of clauses 25 to 32, and the information indicating the at least one confidence score includes at least one quantized value that is based on the at least one confidence score.

Clause 34 is the method of any of clauses 25 to 33, and the report includes a set of IDs respectively associated with each beam of the at least one beam that corresponds to a respective predicted value of the at least one predicted value that satisfies a threshold, and the set of IDs are based on a respective confidence score of the at least one confidence score.

Clause 35 is the method of any of clauses 25 to 34, further including: transmitting, to the second network node, information indicating at least one quantity of bits for reporting the information indicating the at least one confidence score.

Clause 36 is the method of clause 35, and the at least one quantity of bits includes a first quantity of bits, and each respective confidence score of the at least one confidence score is represented by the first quantity of bits in the information indicating the at least one confidence score.

Clause 37 is the method of clause 35, and the at least one quantity of bits includes a first quantity of bits and a second quantity of bits, and the first quantity of bits is less than the second quantity of bits.

Clause 38 is the method of clause 37, and the at least one confidence score includes a first confidence score and one or more other confidence scores, and each respective confidence score of the one or more other confidence scores is represented by the first quantity of bits in the information indicating the at least one confidence score, and the first confidence score is represented by the second quantity of bits in the information indicating the at least one confidence score.

Clause 39 is the method of clause 37, and each respective confidence score of the at least one confidence score is represented by the first quantity of bits in the information indicating the at least one confidence score, and the report includes information indicating a first predicted value of the at least one predicted value and a second predicted value of the at least one predicted value, and the first predicted value is represented by the first quantity of bits in the information indicating the first predicted value, and the second predicted value is represented by the second quantity of bits in the information indicating the second predicted value.

Clause 40 is the method of any of clauses 25 to 39, and the at least one confidence score is based on at least one of a most recently predicted value corresponding to the at least one beam or a filtered over instantaneous predicted value corresponding to the at least one beam, and the at least one predicted value includes the most recently predicted value or the filtered over instantaneous predicted value.

Clause 41 is the method of any of clauses 25 to 40, and the report includes time information indicative of a respective time to which each respective confidence score of the at least one confidence score corresponds.

Clause 42 is the method of any of clauses 25 to 41, further including: determining the selected beam of the set of beams based on the information indicating the at least one confidence score that is associated with on the at least one predicted value.

Clause 43 is a first network node, comprising: a memory; and at least one processor coupled to the memory, wherein the at least one processor is configured to: determine a set of values respectively corresponding to a set of signals received from a second network node, wherein the set of signals corresponds to a set of beams; determine, based on the set of values, at least one predicted value, wherein the at least one predicted value corresponds to at least one beam with which to communicate with the second network node; and transmit, to the second network node, a report, wherein the report includes information indicating at least one confidence score that is associated with the at least one predicted value.

Clause 44 is the first network node of clause 43, wherein to determine the set of values respectively corresponding to the set of signals, the at least one processor is configured to generate measurement information corresponding to the set of signals, wherein: the measurement information includes the set of values; or the at least one processor is further configured to process the measurement information resulting in the set of values.

Clause 45 is the first network node of clause 43, wherein each respective value of the set of values corresponds to a respective reference signal receive power (RSRP), and the at least one predicted value corresponds to at least one predicted RSRP.

Clause 46 is the first network node of clause 45, wherein the at least one predicted RSRP comprises a predicted mean RSRP.

Clause 47 is the first network node of clause 43, wherein each value of the set of values respectively corresponds to: a reference signal receive power (RSRP), a signal-to-noise ratio (SNR), a signal-to-interference-plus-noise ratio (SINR), a reference signal receive quality (RSRQ), a channel quality indicator (CQI), or a reference signal strength indicator (RSSI).

Clause 48 is the first network node of clause 43, wherein the at least one predicted value comprises a predicted mean value corresponding to at least one of: a reference signal receive power (RSRP), a signal-to-noise ratio (SNR), a signal-to-interference-plus-noise ratio (SINR), a reference signal receive quality (RSRQ), a channel quality indicator (CQI), or a reference signal strength indicator (RSSI).

Clause 49 is the first network node of clause 43, wherein the at least one processor is further configured to: determine the at least one confidence score associated with the at least one predicted value.

Clause 50 is the first network node of clause 43, wherein the at least one confidence score comprises at least one of a variance, a standard deviation, a probability, or a likelihood.

Clause 51 is the first network node of clause 43, wherein the at least one confidence score is indicative of reliability of the at least one predicted value.

Clause 52 is the first network node of clause 43, wherein the information indicating the at least one confidence score comprises at least one quantized value that is based on the at least one confidence score.

Clause 53 is the first network node of clause 43, wherein the report includes a set of identifiers (IDs) respectively associated with each beam of the at least one beam that corresponds to a respective predicted value of the at least one predicted value that satisfies a threshold, wherein the set of IDs are based on a respective confidence score of the at least one confidence score.

Clause 54 is the first network node of clause 43, wherein the at least one processor is further configured to: receive, from the second network node, information indicating at least one quantity of bits.

Clause 55 is the first network node of clause 54, wherein the at least one quantity of bits includes a first quantity of bits, and wherein each respective confidence score of the at least one confidence score is represented by the first quantity of bits in the information indicating the at least one confidence score.

Clause 56 is the first network node of clause 54, wherein the at least one quantity of bits includes a first quantity of bits and a second quantity of bits, wherein the first quantity of bits is less than the second quantity of bits.

Clause 57 is the first network node of clause 56, wherein the at least one confidence score includes a first confidence score and one or more other confidence scores, wherein each respective confidence score of the one or more other confidence scores is represented by the first quantity of bits in the information indicating the at least one confidence score, and wherein the first confidence score is represented by the second quantity of bits in the information indicating the at least one confidence score.

Clause 58 is the first network node of clause 56, wherein each respective confidence score of the at least one confidence score is represented by the first quantity of bits in the information indicating the at least one confidence score, wherein the report includes information indicating a first predicted value of the at least one predicted value and a second predicted value of the at least one predicted value, wherein the first predicted value is represented by the first quantity of bits in the information indicating the first predicted value, and wherein the second predicted value is represented by the second quantity of bits in the information indicating the second predicted value.

Clause 59 is the first network node of clause 43, wherein the report includes at least one of: at least one value of the set of values, a first indication that the at least one value of the set of values is measured, the at least one predicted value, or a second indication that the at least one predicted value corresponds to a prediction.

Clause 60 is the first network node of clause 59, wherein the at least one processor is further configured to: receive, from the second network node, report content information indicative of information to be included the report, wherein at least one of the first indication or the second indication is based on the report content information.

Clause 61 is the first network node of clause 43, wherein the at least one confidence score is based on at least one of a most recently predicted value corresponding to the at least one beam or a filtered over instantaneous predicted value corresponding to the at least one beam, wherein the at least one predicted value includes the most recently predicted value or the filtered over instantaneous predicted value.

Clause 62 is the first network node of clause 43, wherein the report includes time information indicative of a respective time to which each respective confidence score of the at least one confidence score corresponds.

Clause 63 is the first network node of clause 43, wherein to determine the at least one predicted value, the at least one processor is configured to: input the set of values into a function; and obtain the at least one predicted value as output of the function based on inputting the set of values.

Clause 64 is the first network node of clause 63, wherein the function comprises at least one of a neural network, a deep-learning model, or a filter-based algorithm.

Clause 65 is the first network node of clause 43, wherein to determine the at least one predicted value, the at least one processor is configured to: determine the at least one predicted value based on at least one of a battery status of the first network node, a processor utilization of the first network node, or a capability of the first network node.

Clause 66 is the first network node of clause 43, wherein the at least one processor is further configured to: receive, from the network node, report content information indicative of information to be included the report, wherein the report includes, based on the report content information, the information indicating the at least one confidence score.

Clause 67 is a first network node comprising: a memory; and at least one processor coupled to the memory, wherein the at least one processor is configured to: receive, from a second network node, a report including information indicating at least one confidence score associated with at least one predicted value corresponding to at least one beam with which to communicate with the second network node; and communicate with the second network node using a selected beam that is based on the information indicating the at least one confidence score.

Clause 68 is the first network node of clause 67, wherein the at least one processor is further configured to: transmit, to the second network node, information configuring the second network node to report the information indicating at least one confidence score, wherein the report is received based on the information configuring the second network node to report the information indicating the at least one confidence score.

Clause 69 is the first network node of clause 67, wherein the report further comprises at least one of: at least one of a set of values respectively corresponding to a set of signals transmitted by the first network node, wherein the set of signals corresponds to a set of beams, a first indication that the at least one of the set of values is measured, the at least one predicted value, or a second indication that the at least one predicted value corresponds to a prediction.

Clause 70 is the first network node of clause 69, wherein the at least one processor is further configured to: transmit, to the second network node, report content information indicative of information to be included the report, wherein at least one of the first indication or the second indication is based on the report content information.

Clause 71 is the first network node of clause 69, wherein the at least one of the set of values corresponds to: a reference signal receive power (RSRP), a signal-to-noise ratio (SNR), a signal-to-interference-plus-noise ratio (SINR), a reference signal receive quality (RSRQ), a channel quality indicator (CQI), or a reference signal strength indicator (RSSI).

Clause 72 is the first network node of clause 69, wherein the at least one predicted value comprises a predicted mean value corresponding to at least one of: a reference signal receive power (RSRP), a signal-to-noise ratio (SNR), a signal-to-interference-plus-noise ratio (SINR), a reference signal receive quality (RSRQ), a channel quality indicator (CQI), or a reference signal strength indicator (RSSI).

Clause 73 is the first network node of clause 67, wherein the at least one confidence score comprises at least one of a variance, a standard deviation, a probability, or a likelihood.

Clause 74 is the first network node of clause 67, wherein the confidence score is indicative of reliability of the at least one predicted value.

Clause 75 is the first network node of clause 67, wherein the information indicating the at least one confidence score comprises at least one quantized value that is based on the at least one confidence score.

Clause 76 is the first network node of clause 67, wherein the report includes a set of identifiers (IDs) respectively associated with each beam of the at least one beam that corresponds to a respective predicted value of the at least one predicted value that satisfies a threshold, wherein the set of IDs are based on a respective confidence score of the at least one confidence score.

Clause 77 is the first network node of clause 67, wherein the at least one processor is further configured to: transmit, to the second network node, information indicating at least one quantity of bits for reporting the information indicating the at least one confidence score.

Clause 78 is the first network node of clause 77, wherein the at least one quantity of bits includes a first quantity of bits, and wherein each respective confidence score of the at least one confidence score is represented by the first quantity of bits in the information indicating the at least one confidence score.

Clause 79 is the first network node of clause 77, wherein the at least one quantity of bits includes a first quantity of bits and a second quantity of bits, wherein the first quantity of bits is less than the second quantity of bits.

Clause 80 is the first network node of clause 79, wherein the at least one confidence score includes a first confidence score and one or more other confidence scores, wherein each respective confidence score of the one or more other confidence scores is represented by the first quantity of bits in the information indicating the at least one confidence score, and wherein the first confidence score is represented by the second quantity of bits in the information indicating the at least one confidence score.

Clause 81 is the first network node of clause 79, wherein each respective confidence score of the at least one confidence score is represented by the first quantity of bits in the information indicating the at least one confidence score, wherein the report includes information indicating a first predicted value of the at least one predicted value and a second predicted value of the at least one predicted value, wherein the first predicted value is represented by the first quantity of bits in the information indicating the first predicted value, and wherein the second predicted value is represented by the second quantity of bits in the information indicating the second predicted value.

Clause 82 is the first network node of clause 67, wherein the at least one confidence score is based on at least one of a most recently predicted value corresponding to the at least one beam or a filtered over instantaneous predicted value corresponding to the at least one beam, wherein the at least one predicted value includes the most recently predicted value or the filtered over instantaneous predicted value.

Clause 83 is the first network node of clause 67, wherein the report includes time information indicative of a respective time to which each respective confidence score of the at least one confidence score corresponds.

Clause 84 is the first network node of clause 67, wherein the at least one processor is further configured to determine the selected beam of the set of beams based on the information indicating the at least one confidence score that is associated with on the at least one predicted value.

Clause 85 is a first network node, comprising: a memory; and at least one processor coupled to the memory, wherein the at least one processor is configured to: determine a set of values respectively corresponding to a set of signals received from a second network node, wherein the set of signals corresponds to a set of beams; determine, based on the set of values, at least one predicted value, wherein the at least one predicted value corresponds to at least one beam with which to communicate with the second network node; and transmit, to the second network node, a report, wherein the report includes information indicating at least one confidence score that is associated with the at least one predicted value.

Clause 86 is the first network node of clause 85, wherein to determine the set of values respectively corresponding to the set of signals, the at least one processor is configured to generate measurement information corresponding to the set of signals, wherein: the measurement information includes the set of values; or the at least one processor is further configured to process the measurement information resulting in the set of values.

Clause 87 is the first network node of any of clauses 85 and 86, wherein each respective value of the set of values corresponds to a respective reference signal receive power (RSRP), and the at least one predicted value corresponds to at least one predicted RSRP.

Clause 88 is the first network node of clause 87, wherein the at least one predicted RSRP comprises a predicted mean RSRP.

Clause 89 is the first network node of any of clauses 85-88, wherein each value of the set of values respectively corresponds to: a reference signal receive power (RSRP), a signal-to-noise ratio (SNR), a signal-to-interference-plus-noise ratio (SINR), a reference signal receive quality (RSRQ), a channel quality indicator (CQI), or a reference signal strength indicator (RSSI).

Clause 90 is the first network node of any of clauses 85-89, wherein the at least one predicted value comprises a predicted mean value corresponding to at least one of: a reference signal receive power (RSRP), a signal-to-noise ratio (SNR), a signal-to-interference-plus-noise ratio (SINR), a reference signal receive quality (RSRQ), a channel quality indicator (CQI), or a reference signal strength indicator (RSSI).

Clause 91 is the first network node of any of clauses 85-90, wherein the at least one processor is further configured to determine the at least one confidence score associated with the at least one predicted value.

Clause 92 is the first network node of any of clauses 85-91, wherein the at least one confidence score comprises at least one of a variance, a standard deviation, a probability, or a likelihood.

Clause 93 is the first network node of any of clauses 85-91, wherein the at least one confidence score is indicative of reliability of the at least one predicted value.

Clause 94 is the first network node of any of clauses 85-93, wherein the information indicating the at least one confidence score comprises at least one quantized value that is based on the at least one confidence score.

Clause 95 is the first network node of any of clauses 85-94, wherein the report includes a set of identifiers (IDs) respectively associated with each beam of the at least one beam that corresponds to a respective predicted value of the at least one predicted value that satisfies a threshold, wherein the set of IDs are based on a respective confidence score of the at least one confidence score.

Clause 96 is the first network node of any of clauses 85-95, wherein the at least one processor is further configured to receive, from the second network node, information indicating at least one quantity of bits.

Clause 97 is the first network node of clause 96, wherein the at least one quantity of bits includes a first quantity of bits, and wherein each respective confidence score of the at least one confidence score is represented by the first quantity of bits in the information indicating the at least one confidence score.

Clause 98 is the first network node of any of clauses 96 and 97, wherein the at least one quantity of bits includes a first quantity of bits and a second quantity of bits, wherein the first quantity of bits is less than the second quantity of bits.

Clause 99 is the first network node of clause 98, wherein the at least one confidence score includes a first confidence score and one or more other confidence scores, wherein each respective confidence score of the one or more other confidence scores is represented by the first quantity of bits in the information indicating the at least one confidence score, and wherein the first confidence score is represented by the second quantity of bits in the information indicating the at least one confidence score.

Clause 100 is the first network node of clause 98, wherein each respective confidence score of the at least one confidence score is represented by the first quantity of bits in the information indicating the at least one confidence score, wherein the report includes information indicating a first predicted value of the at least one predicted value and a second predicted value of the at least one predicted value, wherein the first predicted value is represented by the first quantity of bits in the information indicating the first predicted value, and wherein the second predicted value is represented by the second quantity of bits in the information indicating the second predicted value.

Clause 101 is the first network node of any of clauses 85-100, wherein the report includes at least one of: at least one value of the set of values, a first indication that the at least one value of the set of values is measured, the at least one predicted value, or a second indication that the at least one predicted value corresponds to a prediction.

Clause 102 is the first network node of clause 101, wherein the at least one processor is further configured to: receive, from the second network node, report content information indicative of information to be included the report, wherein at least one of the first indication or the second indication is based on the report content information.

Clause 103 is the first network node of any of clauses 85-102, wherein the at least one confidence score is based on at least one of a most recently predicted value corresponding to the at least one beam or a filtered over instantaneous predicted value corresponding to the at least one beam, wherein the at least one predicted value includes the most recently predicted value or the filtered over instantaneous predicted value.

Clause 104 is the first network node of any of clauses 85-103, wherein the report includes time information indicative of a respective time to which each respective confidence score of the at least one confidence score corresponds.

Clause 105 is the first network node of any of clauses 85-104, wherein to determine the at least one predicted value, the at least one processor is configured to: input the set of values into a function; and obtain the at least one predicted value as output of the function based on inputting the set of values.

Clause 106 is the first network node of clause 105, wherein the function comprises at least one of a neural network, a deep-learning model, or a filter-based algorithm.

Clause 107 is the first network node of any of clauses 85-106, wherein to determine the at least one predicted value, the at least one processor is configured to determine the at least one predicted value based on at least one of a battery status of the first network node, a processor utilization of the first network node, or a capability of the first network node.

Clause 108 is the first network node of any of clauses 85-107, wherein the at least one processor is further configured to receive, from the network node, report content information indicative of information to be included the report, wherein the report includes, based on the report content information, the information indicating the at least one confidence score.

Clause 109 is a first network node comprising: a memory; and at least one processor coupled to the memory, wherein the at least one processor is configured to:receive, from a second network node, a report including information indicating at least one confidence score associated with at least one predicted value corresponding to at least one beam with which to communicate with the second network node; and communicate with the second network node using a selected beam that is based on the information indicating the at least one confidence score.

Clause 110 is the first network node of clause 109, wherein the at least one processor is further configured to transmit, to the second network node, information configuring the second network node to report the information indicating at least one confidence score, wherein the report is received based on the information configuring the second network node to report the information indicating the at least one confidence score.

Clause 111 is the first network node of any of clauses 109 and 110, wherein the report further comprises at least one of: at least one of a set of values respectively corresponding to a set of signals transmitted by the first network node, wherein the set of signals corresponds to a set of beams, a first indication that the at least one of the set of values is measured, the at least one predicted value, or a second indication that the at least one predicted value corresponds to a prediction.

Clause 112 is the first network node of clause 111, wherein the at least one processor is further configured to transmit, to the second network node, report content information indicative of information to be included the report, wherein at least one of the first indication or the second indication is based on the report content information.

Clause 113 is the first network node of any of clauses 111 and 112, wherein the at least one of the set of values corresponds to: a reference signal receive power (RSRP), a signal-to-noise ratio (SNR), a signal-to-interference-plus-noise ratio (SINR), a reference signal receive quality (RSRQ), a channel quality indicator (CQI), or a reference signal strength indicator (RS SI).

Clause 114 is the first network node of any of clauses 111-113, wherein the at least one predicted value comprises a predicted mean value corresponding to at least one of: a reference signal receive power (RSRP), a signal-to-noise ratio (SNR), a signal-to-interference-plus-noise ratio (SINR), a reference signal receive quality (RSRQ), a channel quality indicator (CQI), or a reference signal strength indicator (RSSI).

Clause 115 is the first network node of any of clauses 109-114, wherein the at least one confidence score comprises at least one of a variance, a standard deviation, a probability, or a likelihood.

Clause 116 is the first network node of any of clauses 109-115, wherein the confidence score is indicative of reliability of the at least one predicted value.

Clause 117 is the first network node of any of clauses 109-116, wherein the information indicating the at least one confidence score comprises at least one quantized value that is based on the at least one confidence score.

Clause 118 is the first network node of any of clauses 109-117, wherein the report includes a set of identifiers (IDs) respectively associated with each beam of the at least one beam that corresponds to a respective predicted value of the at least one predicted value that satisfies a threshold, wherein the set of IDs are based on a respective confidence score of the at least one confidence score.

Clause 119 is the first network node of any of clause 109-118, wherein the at least one processor is further configured to: transmit, to the second network node, information indicating at least one quantity of bits for reporting the information indicating the at least one confidence score.

Clause 120 is the first network node of clause 119, wherein the at least one quantity of bits includes a first quantity of bits, and wherein each respective confidence score of the at least one confidence score is represented by the first quantity of bits in the information indicating the at least one confidence score.

Clause 121 is the first network node of any of clauses 119 and 120, wherein the at least one quantity of bits includes a first quantity of bits and a second quantity of bits, wherein the first quantity of bits is less than the second quantity of bits.

Clause 122 is the first network node of clause 121, wherein the at least one confidence score includes a first confidence score and one or more other confidence scores, wherein each respective confidence score of the one or more other confidence scores is represented by the first quantity of bits in the information indicating the at least one confidence score, and wherein the first confidence score is represented by the second quantity of bits in the information indicating the at least one confidence score.

Clause 123 is the first network node of any of clauses 121 and 122, wherein each respective confidence score of the at least one confidence score is represented by the first quantity of bits in the information indicating the at least one confidence score, wherein the report includes information indicating a first predicted value of the at least one predicted value and a second predicted value of the at least one predicted value, wherein the first predicted value is represented by the first quantity of bits in the information indicating the first predicted value, and wherein the second predicted value is represented by the second quantity of bits in the information indicating the second predicted value.

Clause 124 is the first network node of any of clauses 109-123, wherein the at least one confidence score is based on at least one of a most recently predicted value corresponding to the at least one beam or a filtered over instantaneous predicted value corresponding to the at least one beam, wherein the at least one predicted value includes the most recently predicted value or the filtered over instantaneous predicted value.

Clause 125 is the first network node of any of clauses 109-124, wherein the report includes time information indicative of a respective time to which each respective confidence score of the at least one confidence score corresponds.

Clause 126 is the first network node of any of clauses 109-125, wherein the at least one processor is further configured to determine the selected beam of the set of beams based on the information indicating the at least one confidence score that is associated with on the at least one predicted value.

The previous description is provided to enable one of ordinary skill in the art to practice the various aspects described herein. Various modifications to these aspects will be readily apparent to those having ordinary skill in the art, and the generic principles defined herein may be applied to other aspects. Thus, the claims are not intended to be limited to the aspects shown herein, but is to be accorded the full scope consistent with the language. Thus, the language employed herein is not intended to limit the scope of the claims to only those aspects shown herein, but is to be accorded the full scope consistent with the language of the claims.

As one example, the language “determining” may encompass a wide variety of actions, and so may not be limited to the concepts and aspects explicitly described or illustrated by the present disclosure. In some contexts, “determining” may include calculating, computing, processing, measuring, deriving, investigating, looking up (e.g., looking up in a table, a database or another data structure), ascertaining, resolving, selecting, choosing, establishing, and so forth. In some other contexts, “determining” may include communication and/or memory operations/procedures through which information or value(s) are acquired, such as “receiving” (e.g., receiving information), “accessing” (e.g., accessing data in a memory), “detecting,” and the like.

As another example, reference to an element in the singular is not intended to mean “one and only one” unless specifically stated, but rather “one or more.” Further, terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action or event, but rather imply that if a condition is met then another action or event will occur, but without requiring a specific or immediate time constraint or direct correlation for the other action or event to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As yet another example, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

As still another example, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

What is claimed is:

1. A first network node, comprising:
a memory; and
at least one processor coupled to the memory, wherein the at least one processor is configured to:
determine a set of values respectively corresponding to a set of signals received from a second network node, wherein the set of signals corresponds to a set of beams;
determine, based on the set of values, at least one predicted value, wherein the at least one predicted value corresponds to at least one beam with which to communicate with the second network node; and
transmit, to the second network node, a report, wherein the report includes information indicating at least one confidence score that is associated with the at least one predicted value.

2. The first network node of claim 1, wherein to determine the set of values respectively corresponding to the set of signals, the at least one processor is configured to generate measurement information corresponding to the set of signals, wherein:
the measurement information includes the set of values; or
the at least one processor is further configured to process the measurement information resulting in the set of values.

3. The first network node of claim 1, wherein each respective value of the set of values corresponds to a respective reference signal receive power (RSRP), and the at least one predicted value corresponds to at least one predicted RSRP.

4. The first network node of claim 3, wherein the at least one predicted RSRP comprises a predicted mean RSRP.

5. The first network node of claim 1, wherein each value of the set of values respectively corresponds to:
a reference signal receive power (RSRP),
a signal-to-noise ratio (SNR),
a signal-to-interference-plus-noise ratio (SINR),
a reference signal receive quality (RSRQ),
a channel quality indicator (CQI), or
a reference signal strength indicator (RSSI).

6. The first network node of claim 1, wherein the at least one predicted value comprises a predicted mean value corresponding to at least one of:
a reference signal receive power (RSRP),
a signal-to-noise ratio (SNR),
a signal-to-interference-plus-noise ratio (SINR),
a reference signal receive quality (RSRQ),
a channel quality indicator (CQI), or
a reference signal strength indicator (RSSI).

7. The first network node of claim 1, wherein the at least one processor is further configured to:
determine the at least one confidence score associated with the at least one predicted value.

8. The first network node of claim 1, wherein the at least one confidence score comprises at least one of a variance, a standard deviation, a probability, or a likelihood.

9. The first network node of claim 1, wherein the at least one confidence score is indicative of reliability of the at least one predicted value.

10. The first network node of claim 1, wherein the information indicating the at least one confidence score comprises at least one quantized value that is based on the at least one confidence score.

11. The first network node of claim 1, wherein the report includes a set of identifiers (IDs) respectively associated with each beam of the at least one beam that corresponds to a respective predicted value of the at least one predicted value that satisfies a threshold, wherein the set of IDs are based on a respective confidence score of the at least one confidence score.

12. The first network node of claim 1, wherein the at least one processor is further configured to:
receive, from the second network node, information indicating at least one quantity of bits.

13. The first network node of claim 12, wherein the at least one quantity of bits includes a first quantity of bits, and wherein each respective confidence score of the at least one confidence score is represented by the first quantity of bits in the information indicating the at least one confidence score.

14. The first network node of claim 12, wherein the at least one quantity of bits includes a first quantity of bits and a second quantity of bits, wherein the first quantity of bits is less than the second quantity of bits.

15. The first network node of claim 14, wherein the at least one confidence score includes a first confidence score and one or more other confidence scores, wherein each respective confidence score of the one or more other confidence scores is represented by the first quantity of bits in the information indicating the at least one confidence score, and wherein the first confidence score is represented by the second quantity of bits in the information indicating the at least one confidence score.

16. The first network node of claim 14, wherein each respective confidence score of the at least one confidence score is represented by the first quantity of bits in the information indicating the at least one confidence score, wherein the report includes information indicating a first predicted value of the at least one predicted value and a second predicted value of the at least one predicted value, wherein the first predicted value is represented by the first quantity of bits in the information indicating the first predicted value, and wherein the second predicted value is represented by the second quantity of bits in the information indicating the second predicted value.

17. The first network node of claim 1, wherein the report includes at least one of:
at least one value of the set of values,
a first indication that the at least one value of the set of values is measured,
the at least one predicted value, or
a second indication that the at least one predicted value corresponds to a prediction.

18. The first network node of claim 17, wherein the at least one processor is further configured to:
receive, from the second network node, report content information indicative of information to be included the report, wherein at least one of the first indication or the second indication is based on the report content information.

19. The first network node of claim 1, wherein the at least one confidence score is based on at least one of a most recently predicted value corresponding to the at least one beam or a filtered over instantaneous predicted value corresponding to the at least one beam, wherein the at least one predicted value includes the most recently predicted value or the filtered over instantaneous predicted value.

20. The first network node of claim 1, wherein the report includes time information indicative of a respective time to which each respective confidence score of the at least one confidence score corresponds.

21. The first network node of claim 1, wherein to determine the at least one predicted value, the at least one processor is configured to:
input the set of values into a function; and
obtain the at least one predicted value as output of the function based on inputting the set of values.

22. The first network node of claim 21, wherein the function comprises at least one of a neural network, a deep-learning model, or a filter-based algorithm.

23. The first network node of claim 1, wherein to determine the at least one predicted value, the at least one processor is configured to:
determine the at least one predicted value based on at least one of a battery status of the first network node, a processor utilization of the first network node, or a capability of the first network node.

24. The first network node of claim 1, wherein the at least one processor is further configured to:
receive, from the network node, report content information indicative of information to be included the report, wherein the report includes, based on the report content information, the information indicating the at least one confidence score.

25. A first network node comprising:
a memory; and
at least one processor coupled to the memory, wherein the at least one processor is configured to:
receive, from a second network node, a report including information indicating at least one confidence score associated with at least one predicted value corresponding to at least one beam with which to communicate with the second network node; and
communicate with the second network node using a selected beam that is based on the information indicating the at least one confidence score.

26. The first network node of claim 25, wherein the at least one processor is further configured to:
transmit, to the second network node, information configuring the second network node to report the information indicating at least one confidence score, wherein the report is received based on the information configuring the second network node to report the information indicating the at least one confidence score.

27. The first network node of claim 25, wherein the report further comprises at least one of:
at least one of a set of values respectively corresponding to a set of signals transmitted by the first network node, wherein the set of signals corresponds to a set of beams,
a first indication that the at least one of the set of values is measured,
the at least one predicted value, or
a second indication that the at least one predicted value corresponds to a prediction.

28. The first network node of claim 27, wherein the at least one processor is further configured to:
transmit, to the second network node, report content information indicative of information to be included the report, wherein at least one of the first indication or the second indication is based on the report content information.

29. The first network node of claim 27, wherein the at least one of the set of values corresponds to:
a reference signal receive power (RSRP),
a signal-to-noise ratio (SNR),
a signal-to-interference-plus-noise ratio (SINR),
a reference signal receive quality (RSRQ),
a channel quality indicator (CQI), or
a reference signal strength indicator (RSSI).

30. The first network node of claim 27, wherein the at least one predicted value comprises a predicted mean value corresponding to at least one of:
a reference signal receive power (RSRP),
a signal-to-noise ratio (SNR),
a signal-to-interference-plus-noise ratio (SINR),
a reference signal receive quality (RSRQ),
a channel quality indicator (CQI), or
a reference signal strength indicator (RSSI).

31. The first network node of claim 25, wherein the at least one confidence score comprises at least one of a variance, a standard deviation, a probability, or a likelihood.

32. The first network node of claim 25, wherein the confidence score is indicative of reliability of the at least one predicted value.

33. The first network node of claim 25, wherein the information indicating the at least one confidence score comprises at least one quantized value that is based on the at least one confidence score.

34. The first network node of claim 25, wherein the report includes a set of identifiers (IDs) respectively associated with each beam of the at least one beam that corresponds to a respective predicted value of the at least one predicted value that satisfies a threshold, wherein the set of IDs are based on a respective confidence score of the at least one confidence score.

35. The first network node of claim 25, wherein the at least one processor is further configured to:
transmit, to the second network node, information indicating at least one quantity of bits for reporting the information indicating the at least one confidence score.

36. The first network node of claim 35, wherein the at least one quantity of bits includes a first quantity of bits, and wherein each respective confidence score of the at least one confidence score is represented by the first quantity of bits in the information indicating the at least one confidence score.

37. The first network node of claim 35, wherein the at least one quantity of bits includes a first quantity of bits and a second quantity of bits, wherein the first quantity of bits is less than the second quantity of bits.

38. The first network node of claim 37, wherein the at least one confidence score includes a first confidence score and one or more other confidence scores, wherein each respective confidence score of the one or more other confidence scores is represented by the first quantity of bits in the information indicating the at least one confidence score, and wherein the first confidence score is represented by the second quantity of bits in the information indicating the at least one confidence score.

39. The first network node of claim 37, wherein each respective confidence score of the at least one confidence score is represented by the first quantity of bits in the information indicating the at least one confidence score, wherein the report includes information indicating a first predicted value of the at least one predicted value and a second predicted value of the at least one predicted value, wherein the first predicted value is represented by the first quantity of bits in the information indicating the first predicted value, and wherein the second predicted value is represented by the second quantity of bits in the information indicating the second predicted value.

40. The first network node of claim 25, wherein the at least one confidence score is based on at least one of a most recently predicted value corresponding to the at least one beam or a filtered over instantaneous predicted value corresponding to the at least one beam, wherein the at least one predicted value includes the most recently predicted value or the filtered over instantaneous predicted value.

41. The first network node of claim 25, wherein the report includes time information indicative of a respective time to which each respective confidence score of the at least one confidence score corresponds.

42. The first network node of claim 25, wherein the at least one processor is further configured to determine the selected beam of the set of beams based on the information indicating the at least one confidence score that is associated with on the at least one predicted value.
